(19) United States
(12) Patent Application Publication
(10) Pub. No.: US 2021/0003754 A1
(43) Pub. Date: Jan. 7, 2021

(54) CORE-SHELL PARTICLES AND METHODS OF MAKING AND USING THEREOF

(71) Applicant: Johnson & Johnson Vision Care, Inc., Jacksonville, FL (US)

(72) Inventors: Frank Gu, Toronto (CA); Paul Chen, Toronto (CA); Harish Krishnakumar, Waterloo (CA)

(21) Appl. No.: 16/885,808

(22) Filed: May 28, 2020

Related U.S. Application Data
(60) Provisional application No. 62/869,736, filed on Jul. 2, 2019.

(51) Int. Cl. G02B 5/22; G02B 5/00; G02B 1/04; G02C 7/10

(52) U.S. Cl. CPC G02B 5/22; G02B 5/008; G02B 2207/101; G02C 7/10; G02B 1/041

(57) ABSTRACT

Described are core-shell particles which exhibit tunable photophysical properties, allowing them to absorb, scatter, and/or extinguish specific wavelengths of light (e.g., specific wavelengths of blue light). The core-shell particles can be incorporated as tunable optical filters in optically transparent substrates to produce devices, including ophthalmic devices such as contact lenses.

### RELATED APPLICATIONS

This application claims priority to U.S. Provisional Patent Application Ser. No. 62/869,736, filed Jul. 2, 2019, which is incorporated herein by reference in its entirety.

### TECHNICAL FIELD

This application generally relates to optical filters. More particularly, this application relates to core-shell particles which exhibit tunable photophysical properties, allowing them to absorb, scatter, and/or extinguish specific wavelengths of light (e.g., specific wavelengths of blue light). The core-shell particles can be incorporated as tunable optical filters in optically transparent substrates to produce devices, including ophthalmic devices such as contact lenses.

### BACKGROUND

The electromagnetic spectrum is the range of all possible frequencies of electromagnetic radiation, including radio waves, millimeter waves, microwaves, infrared, visible light, ultra-violet (UVA and UVB), x-rays, and gamma rays. The Earth's ozone layer absorbs wavelengths up to approximately 286 nm, shielding human beings from exposure to electromagnetic radiation with the highest energy. However, humans are exposed to electromagnetic radiation having wavelengths above 286 nm. Most of this radiation falls within the human visual spectrum, which includes light having a wavelength ranging from approximately 400 nanometers (nm) to approximately 700 nm.

Various electromagnetic wavelengths can have physical effects on the human body. By way of example, the human retina responds to visible light (400-700 nm). The shorter wavelengths of visible light pose the greatest hazard to human health because they inversely contain greater energy. In particular, blue light, ranging in wavelength from approximately 400 nm to approximately 500 nm, has been shown to be the portion of the visible spectrum that produces the most photochemical damage to animal retinal pigment epithelium (RPE) cells. Cataracts and macular degeneration have been associated with photochemical damage to the intraocular lens and retina, respectively, resulting from blue light exposure. Blue light exposure has also been shown to accelerate proliferation of uveal melanoma cells. Recent research also supports the premise that short wavelength visible light (blue light) may contribute to age related macular degeneration (AMD).

The human retina includes multiple layers. These layers, listed in order from the first exposed to any light entering the eye to the deepest, include the nerve fiber layer, ganglion cells, the inner plexiform layer, bipolar and horizontal cells, the outer plexiform layer, photoreceptors (rods and cones), the retinal pigment epithelium (RPE), Bruch's membrane, and the choroid. When light is absorbed by the human eye's photoreceptor cells (rods and cones), the cells bleach and become unreceptive until they recover. This recovery process is a metabolic process referred to as the “visual cycle.” Absorption of blue light reverses this process prematurely, increasing the risk of oxidative damage. This reversal leads to the buildup of lipofuscin in the RPE layer of the eye. Excessive amounts of lipofuscin lead to the formation of extracellular aggregates termed “drusen” between Bruch's membrane and the RPE of the eye.

Over the course of a person's life, metabolic waste byproducts accumulate within the RPE layer of the eye due to the interaction of light with the retina. Metabolic waste byproducts include certain fluorophores, such as lipofuscin constituent A2E. As this metabolic waste accumulates in the RPE layer of the eye, the body's physiological ability to metabolize waste diminishes, and blue light stimulus causes drusen to be formed in the RPE layer. It is believed that the drusen further interfere with the normal physiology/metabolic activity, contributing to AMD. AMD is the leading cause of irreversible severe visual acuity loss in the United States and Western World. The burden of AMD is expected to increase dramatically in the next 20 years because of the projected shift in population and the overall increase in the number of ageing individuals.

Drusen hinder or block the RPE layer from providing the proper nutrients to the photoreceptors, which leads to damage or even death of these cells. To further complicate this process, it appears that when lipofuscin absorbs blue light in high quantities it becomes toxic, causing further damage and/or death of the RPE cells. It is believed that the lipofuscin constituent A2E is at least partly responsible for the short-wavelength sensitivity of RPE cells. Lipofuscin chromophore A2E exhibits a maximum absorption of approximately 430 nm. The photochemical events resulting from the excitation of A2E can lead to cell death. From a theoretical perspective, the following events appear to take place in the eye: (1) starting from infancy and throughout life, waste buildup, including buildup of lipofuscin, occurs within the RPE; (2) retinal metabolic activity and the eye's ability to deal with this waste typically diminishes with age; (3) macular pigment typically decreases with age, thus filtering out less blue light; (4) blue light causes the accumulating lipofuscin to become toxic, damaging pigment epithelial cells.

The lighting and vision care industries have standards as to human vision exposure to

UVA and UVB radiation. However, no such standard is in place with regard to blue light. For example, in the common fluorescent tubes available today, the glass envelope mostly blocks ultra-violet light but blue light is transmitted with little attenuation. In some cases, the envelope is designed to have enhanced transmission in the blue region of the spectrum. Such artificial sources of light hazard may also cause eye damage.

With a goal of protecting eyes from the potentially harmful effects of blue light, eyewear (e.g., sunglasses, spectacles, goggles, and contact lenses) configured to block blue light has been evaluated. Such eyewear typically employs a yellow dye or pigment (e.g., BPI Filter Vision 450 or BPI Diamond Dye 500) that absorbs incident blue light. As a result, such eyewear typically includes yellow tinted lenses that completely (or nearly completely) block light below a threshold wavelength (e.g., below 500 nm), while also reducing light exposure at longer wavelengths.

However, such eyewear has significant drawbacks for the user. In particular, blue blocking ophthalmic systems may be cosmetically unappealing because of a yellow or amber tint that is produced in lenses by blue blocking. To many people, the appearance of this yellow or amber tint may be undesirable cosmetically. Moreover, the tint may interfere with the normal color perception of a lens user, making it difficult, for example, to correctly perceive the color of a traffic light or sign.

Efforts have been made to compensate for the yellowing effect of conventional blue blocking filters. For example, blue blocking lenses have been treated with additional dyes, such as blue, red or green dyes, to offset the yellowing effect. The treatment causes the additional dyes to become intermixed with the original blue blocking dyes. However, while this technique may reduce yellow in a blue blocked lens, intermixing of the dyes may reduce the effectiveness of the blue blocking by allowing more of the blue light spectrum through. Moreover, these conventional techniques undesirably reduce the overall transmission of light wavelengths other than blue light wavelengths. This unwanted reduction may in turn result in reduced visual acuity for a lens user.

Conventional blue-blocking also reduces visible transmission, which in turn stimulates dilation of the pupil. Dilation of the pupil increases the flux of light to the internal eye structures including the intraocular lens and retina. Since the radiant flux to these structures increases as the square of the pupil diameter, a lens that blocks half of the blue light but, with reduced visible transmission, relaxes the pupil from 2 mm to 3 mm diameter, will actually increase the dose of blue photons to the retina by 12.5%. Protection of the retina from phototoxic light depends on the amount of this light that impinges on the retina, which depends on the transmission properties of the ocular media and also on the dynamic aperture of the pupil.

Another problem with conventional blue-blocking is that it can degrade night vision. Blue light is more important for low-light level or scotopic vision than for bright light or photopic vision, a result which is expressed quantitatively in the luminous sensitivity spectra for scotopic and photopic vision. Accordingly, blue-blocking eyewear that completely (or nearly completely) blocks incident light below a threshold wavelength (e.g., below 500 nm) can significantly impair night vision.

In addition, blue light is known to impact circadian rhythms. Melatonin (N-acetyl-5-methoxytryptamine) is a hormone secreted by the pineal gland. Melatonin, in part, regulates the sleep-wake cycle by chemically causing drowsiness and lowering the body temperature. Blue light having a wavelength of 460 to 480 nm suppresses melatonin production. Accordingly, ensuring proper levels of blue light throughout the day can be important for maintaining acceptable circadian rhythms.

Accordingly, there is a need for materials that can mitigate the harmful effects of blue light while maintaining acceptable photopic vision, scotopic vision, color vision, and circadian rhythms.

### SUMMARY

Provided herein are particles that exhibit tunable photophysical properties. The particles can be engineered to absorb, scatter, and/or extinguish specific wavelengths of light within the blue region of the electromagnetic spectrum (e.g., between 400 nm and 500 nm). The particles can be incorporated in optically transparent substrates as wavelength-specific optical filters. The particles can absorb, scatter, and/or extinguish specific narrow regions of light in the blue region while allowing significant portions of incident light in other regions of the ultraviolet, infrared, and/or visible spectrum to pass through the material.

The particles can comprise core-shell particles having a plasmonic nanoparticle core comprising a noble metal (e.g., silver); and a shell comprising a dielectric material (e.g., silicon dioxide) surrounding the plasmonic nanoparticle core. By varying the size and shape of the plasmonic nanoparticle core, the optical properties of the plasmonic nanoparticle core (which arise through localized surface plasmon resonance) can be tuned. For example, the absorption of the plasmonic nanoparticle core can be tuned within the blue region of the electromagnetic spectrum (e.g., between 400 nm and 500 nm). The dielectric shell enveloping the plasmonic nanoparticle core can reduce the interaction between adjacent plasmonic nanoparticle cores, preventing broadening and/or redshifting of absorbance and/or scattering peak of the plasmonic nanoparticle cores. As a result, the core-shell particles can exhibit absorbance and/or scattering peaks in blue region of the electromagnetic spectrum which are both tunable and relatively narrow.

The size and shape of the plasmonic nanoparticle core can be varied to tune the optical properties of the core-shell particles. In some embodiments, the plasmonic nanoparticle cores of the core-shell particles can have an average particle size of from 5 nm to 100 nm (e.g., from 20 nm to 60 nm), as measured by transmission electron microscopy (TEM). The dimensions of the dielectric shell can also be varied. In some embodiments, the plasmonic nanoparticle cores of the core-shell particles can have an average particle size, the shells of the core-shell particles can have an average thickness, and the ratio of the average particle size to the average thickness can be from 1:5 to 20:1 (e.g., from 2:3 to 6:1), as measured by transmission electron microscopy (TEM). In some examples, the shells of the core-shell particles can have an average thickness of from 1 nm to 100 nm (e.g., from 15 nm to 50 nm), as measured by transmission electron microscopy (TEM).

In some cases, the plasmonic nanoparticle cores have a monodisperse particle size distribution. The shape of the plasmonic nanoparticle cores can vary. In some embodiments, the plasmonic nanoparticle cores can have a polyhedral shape. For example, the plasmonic nanoparticle cores can have a cubic shape, an octahedral shape, a decahedral shape, a cuboctahedral shape, a tetrahedral shape, a rhombic dodecahedral shape, a truncated ditetragonal prismatic shape, or a truncated bitetrahedral shape.

In some cases, the plasmonic nanoparticle cores can have a homogenous particle shape. In other cases, the plasmonic nanoparticle cores can comprise a mixture of particle shapes. For example, in some examples, the plasmonic nanoparticle cores comprise a first population of plasmonic nanoparticle cores having a cubic shape and a second population of plasmonic nanoparticle cores having an octahedral shape.

In some embodiments, the core-shell particles can exhibit a maximum absorption value in a range of from 400 nm to 500 nm (e.g., from 400 nm to 460 nm). In some embodiments, the core-shell particles can exhibit an absorption spectrum having a full-width at half maximum of from 20 nm to 75 nm.

A population of the core-shell particles described herein can be dispersed within an optically transparent substrate. The substrate can comprise, for example, a glass, allyl diglycol carbonate (ADC), a polycarbonate, a polyurethane, a thiourethane, a poly(meth)acrylate, a silicone hydrogel, or a combination thereof. In some embodiments, the substrate can comprise a silicone hydrogel. In certain embodiments, the substrate can comprise a polymer derived from polymerization of a hydrophilic monomer, a silicone-containing component, or combinations thereof.

The core-shell particles can be incorporated in the optically transparent substrate at varying concentrations. By way of example, in some embodiments, the population a population of core-shell particles can be present in the substrate at a concentration of from 0.5% by weight to 10% by weight, based on the total weight of the substrate.

The resulting optically transparent materials can be used to form a variety of different articles, including optical lenses (e.g., eyeglass lenses, camera lenses, contact lenses, etc.), ophthalmic devices (e.g., contact lenses, corneal onlays, corneal inlays, intraocular lenses, overlay lenses, etc.), screen covers (e.g., a transparent sheet configured to cover a computer monitor, tablet screen, or cell phone screen), and housings for electronic devices having LED displays.

### BRIEF DESCRIPTION OF THE DRAWINGS

FIG. 1 is a schematic illustration showing the cross-section of example core-shell particles as well as the relationship between the core-shell structure and the photophysical properties of the core-shell particles.

FIG. 2 is a plot illustrating the normalized absorption of seven different example core-shell particles. As demonstrated by the spectra in FIG. 2, the absorption of the chore-shell particles can be tuned within the blue region of the electromagnetic spectrum (e.g., between 400 nm and 500 nm) by varying the size and shape of the plasmonic nanoparticle core.

FIGS. 3A-3C are TEM micrographs showing three example plasmonic nanoparticle cores: Example W-4 (FIG. 3A; cubic silver particles having an average particle size of 25.4±1.2 nm); Example W-1 (FIG. 3B; cubic silver particles having an average particle size of 43.3±7.2 nm); and Example W-2 (FIG. 3C; a mixture of 44% cubic silver particles having an average particle size of 41.7±0.5 nm, 37% octahedral silver particles having an average particle size of 45.2±0.6 nm, and a small quantity (19%) of silver particles having decahedral, cubocahedral, and truncated bitetrahedral shapes).

FIG. 4 includes TEM micrographs showing a sample of plasmonic silver nanoparticle cores (Example W-19) before and after coating with a dielectric silica shell.

FIG. 5 includes TEM micrographs showing a sample of core-shell particles (Example W-19) post-wash and after storage for approximately one week.

FIG. 6A is a photograph showing example contact lenses prepared containing core-shell particles. The core-shell nanoparticles are dispersed within the silicone hydrogel forming the contact lenses.

FIG. 6B illustrates the effect of UV exposure on contact lenses containing core-shell particles. Lenses 14, 15, 19, and 20 were exposed to UVA light for 24 hours while lenses 16, 17, 21, and 22 were not exposed to UVA light. Lenses 19, 20, 21, and 22 were also heat treated while lenses 14, 15, 16, and 17 were not heat treated. No visible difference was observed between UV exposed lenses and non-exposed lenses.

### DETAILED DESCRIPTION

It is to be understood that the invention is not limited to the details of construction or process steps set forth in the following description. The invention is capable of other embodiments and of being practiced or being carried out in various ways using the teaching herein.

As noted above, provided are core-shell particles that exhibit tunable photophysical properties. The particles can be engineered to absorb, scatter, and/or extinguish specific wavelengths of light within the blue region of the electromagnetic spectrum (e.g., between 400 nm and 500 nm). The particles can comprise core-shell particles having a plasmonic nanoparticle core comprising a noble metal (e.g., silver); and a shell comprising a dielectric material (e.g., silicon dioxide) surrounding the plasmonic nanoparticle core.

By varying the size and shape of the plasmonic nanoparticle core, the optical properties of the plasmonic nanoparticle core (which arise through localized surface plasmon resonance) can be tuned. For example, the absorption of the plasmonic nanoparticle core can be tuned within the blue region of the electromagnetic spectrum (e.g., between 400 nm and 500 nm). The dielectric shell enveloping the plasmonic nanoparticle core can reduce the interaction between adjacent plasmonic nanoparticle cores, preventing broadening and/or redshifting of absorbance and/or scattering peak of the plasmonic nanoparticle core. As a result, the core-shell particles can exhibit absorbance and/or scattering peaks in blue region of the electromagnetic spectrum which are both tunable and relatively narrow. The core-shell particles can therefore be used as blue-light blocking optical filters. For example, particles can be incorporated into an optically transparent substrate to reduce transmission of one or more wavelengths of blue light through the optically transparent substrate.

### Definitions

With respect to the terms used in this disclosure, the following definitions are provided.

Unless defined otherwise, all technical and scientific terms used herein have the same meaning as commonly understood by one of ordinary skill in the art to which the invention belongs. The polymer definitions are consistent with those disclosed in the Compendium of Polymer Terminology and Nomenclature, IUPAC Recommendations 2008, edited by: Richard G. Jones, Jaroslav Kahovec, Robert Stepto, Edward S. Wilks, Michael Hess, Tatsuki Kitayama, and W. Val Metanomski. All publications, patent applications, patents, and other references mentioned herein are incorporated by reference.

As used herein, the term “(meth)” designates optional methyl substitution. Thus, a term such as “(meth)acrylates” denotes both methacrylates and acrylates.

The term “individual” includes humans and vertebrates.

The term “ophthalmic device” refers to any device which resides in or on the eye or any part of the eye, including the ocular surface. These devices can provide optical correction, cosmetic enhancement, vision enhancement, therapeutic benefit (for example as bandages) or delivery of active components such as pharmaceutical and nutraceutical components, or a combination of any of the foregoing. Examples of ophthalmic devices include but are not limited to lenses, optical and ocular inserts, including but not limited to punctal plugs, and the like. “Lenses” include soft contact lenses, hard contact lenses, hybrid contact lenses, intraocular lenses, and overlay lenses. The ophthalmic device may comprise a contact lens.

The term “contact lens” refers to an ophthalmic device that can be placed on the cornea of an individual's eye. The contact lens may provide corrective, cosmetic, or therapeutic benefit, including wound healing, the delivery of drugs or nutraceuticals, diagnostic evaluation or monitoring, ultraviolet light blocking, visible light or glare reduction, or any combination thereof. A contact lens can be of any appropriate material known in the art and can be a soft lens, a hard lens, or a hybrid lens containing at least two distinct portions with different physical, mechanical, or optical properties, such as modulus, water content, light transmission, or combinations thereof.

The ophthalmic devices and lenses described herein may be comprised of silicone hydrogels or conventional hydrogels. Silicone hydrogels typically include at least one hydrophilic monomer and at least one silicone-containing component that are covalently bound to one another in the cured device.

“Target macromolecule” means the macromolecule being synthesized from the reactive monomer mixture comprising monomers, macromers, prepolymers, cross-linkers, initiators, additives, diluents, and the like.

The term “polymerizable compound” means a compound containing one or more polymerizable groups. The term encompasses, for instance, monomers, macromers, oligomers, prepolymers, cross-linkers, and the like.

“Polymerizable groups” are groups that can undergo chain growth polymerization, such as free radical and/or cationic polymerization, for example a carbon-carbon double bond which can polymerize when subjected to radical polymerization initiation conditions. Non-limiting examples of free radical polymerizable groups include (meth)acrylates, styrenes, vinyl ethers, (meth)acrylamides, N-vinyllactams, N-vinylamides, O-vinylcarbamates, O-vinylcarbonates, and other vinyl groups. Preferably, the free radical polymerizable groups comprise (meth)acrylate, (meth)acrylamide, N-vinyl lactam, N-vinylamide, and styryl functional groups, and mixtures of any of the foregoing. More preferably, the free radical polymerizable groups comprise (meth)acrylates, (meth)acrylamides, and mixtures thereof. The polymerizable group may be unsubstituted or substituted. For instance, the nitrogen atom in (meth)acrylamide may be bonded to a hydrogen, or the hydrogen may be replaced with alkyl or cycloalkyl (which themselves may be further substituted).

Any type of free radical polymerization may be used including but not limited to bulk, solution, suspension, and emulsion as well as any of the controlled radical polymerization methods such as stable free radical polymerization, nitroxide-mediated living polymerization, atom transfer radical polymerization, reversible addition fragmentation chain transfer polymerization, organotellurium mediated living radical polymerization, and the like.

A “monomer” is a mono-functional molecule which can undergo chain growth polymerization, and in particular, free radical polymerization, thereby creating a repeating unit in the chemical structure of the target macromolecule. Some monomers have di-functional impurities that can act as cross-linking agents. A “hydrophilic monomer” is also a monomer which yields a clear single phase solution when mixed with deionized water at 25° C. at a concentration of 5 weight percent. A “hydrophilic component” is a monomer, macromer, prepolymer, initiator, cross-linker, additive, or polymer which yields a clear single phase solution when mixed with deionized water at 25° C. at a concentration of 5 weight percent. A “hydrophobic component” is a monomer, macromer, prepolymer, initiator, cross-linker, additive, or polymer which is slightly soluble or insoluble in deionized water at 25° C.

A “macromolecule” is an organic compound having a number average molecular weight of greater than 1500, and may be reactive or non-reactive.

A “macromonomer” or “macromer” is a macromolecule that has one group that can undergo chain growth polymerization, and in particular, free radical polymerization, thereby creating a repeating unit in the chemical structure of the target macromolecule. Typically, the chemical structure of the macromer is different than the chemical structure of the target macromolecule, that is, the repeating unit of the macromer's pendent group is different than the repeating unit of the target macromolecule or its mainchain. The difference between a monomer and a macromer is merely one of chemical structure, molecular weight, and molecular weight distribution of the pendent group. As a result, and as used herein, the patent literature occasionally defines monomers as polymerizable compounds having relatively low molecular weights of about 1,500 Daltons or less, which inherently includes some macromers. In particular, monomethacryloxypropyl terminated mono-n-butyl terminated polydimethylsiloxane (molecular weight =500-1500 g/mol) (mPDMS) and mono-(2-hydroxy-3-methacryloxypropyl)-propyl ether terminated mono-n-butyl terminated polydimethylsiloxane (molecular weight=500-1500 g/mol) (OH-mPDMS) may be referred to as monomers or macromers. Furthermore, the patent literature occasionally defines macromers as having one or more polymerizable groups, essentially broadening the common definition of macromer to include prepolymers. As a result, and as used herein, di-functional and multi-functional macromers, prepolymers, and crosslinkers may be used interchangeably.

A “silicone-containing component” is a monomer, macromer, prepolymer, cross-linker, initiator, additive, or polymer in the reactive mixture with at least one silicon-oxygen bond, typically in the form of siloxy groups, siloxane groups, carbosiloxane groups, and mixtures thereof.

Examples of silicone-containing components which are useful in this invention may be found in U.S. Pat. Nos. 3,808,178, 4,120,570, 4,136,250, 4,153,641, 4,740,533, 5,034,461, 5,070,215, 5,244,981, 5,314,960, 5,331,067, 5,371,147, 5,760,100, 5,849,811, 5,962,548, 5,965,631, 5,998,498, 6,367,929, 6,822,016, 6,943,203, 6,951,894, 7,052,131, 7,247,692, 7,396,890, 7,461,937, 7,468,398, 7,538,146, 7,553,880, 7,572,841, 7,666,921, 7,691,916, 7,786,185, 7,825,170, 7,915,323, 7,994,356, 8,022,158, 8,163,206, 8,273,802, 8,399,538, 8,415,404, 8,420,711, 8,450,387, 8,487,058, 8,568,626, 8,937,110, 8,937,111, 8,940,812, 8,980,972, 9,056,878, 9,125,808, 9,140,825, 9,156,934, 9,170,349, 9,217,813, 9,244,196, 9,244,197, 9,260,544, 9,297,928, 9,297,929, and European Patent No. 080539. These patents are hereby incorporated by reference in their entireties.

A “polymer” is a target macromolecule composed of the repeating units of the monomers used during polymerization.

A “homopolymer” is a polymer made from one monomer; a “copolymer” is a polymer made from two or more monomers; a “terpolymer” is a polymer made from three monomers. A “block copolymer” is composed of compositionally different blocks or segments. Diblock copolymers have two blocks. Triblock copolymers have three blocks. “Comb or graft copolymers” are made from at least one macromer.

A “repeating unit” is the smallest group of atoms in a polymer that corresponds to the polymerization of a specific monomer or macromer.

An “initiator” is a molecule that can decompose into radicals which can subsequently react with a monomer to initiate a free radical polymerization reaction. A thermal initiator decomposes at a certain rate depending on the temperature; typical examples are azo compounds such as 1,1′-azobisisobutyronitrile and 4,4′-azobis(4-cyanovaleric acid), peroxides such as benzoyl peroxide, tert-butyl peroxide, tert-butyl hydroperoxide, tert-butyl peroxybenzoate, dicumyl peroxide, and lauroyl peroxide, peracids such as peracetic acid and potassium persulfate as well as various redox systems. A photo-initiator decomposes by a photochemical process; typical examples are derivatives of benzil, benzoin, acetophenone, benzophenone, camphorquinone, and mixtures thereof as well as various monoacyl and bisacyl phosphine oxides and combinations thereof.

A “cross-linking agent” is a di-functional or multi-functional monomer or macromer which can undergo free radical polymerization at two or more locations on the molecule, thereby creating branch points and a polymeric network. Common examples are ethylene glycol dimethacrylate, tetraethylene glycol dimethacrylate, trimethylolpropane trimethacrylate, methylene bisacrylamide, triallyl cyanurate, and the like.

A “prepolymer” is a reaction product of monomers which contains remaining polymerizable groups capable of undergoing further reaction to form a polymer.

A “polymeric network” is a cross-linked macromolecule that can swell but cannot dissolve in solvents. “Hydrogels” are polymeric networks that swell in water or aqueous solutions, typically absorbing at least 10 weight percent water. “Silicone hydrogels” are hydrogels that are made from at least one silicone-containing component with at least one hydrophilic component. Hydrophilic components may also include non-reactive polymers.

“Conventional hydrogels” refer to polymeric networks made from components without any siloxy, siloxane or carbosiloxane groups. Conventional hydrogels are prepared from reactive mixtures comprising hydrophilic monomers. Examples include 2-hydroxyethyl methacrylate (“HEMA”), N-vinyl pyrrolidone (“NVP”), N,N-dimethylacrylamide (“DMA”) or vinyl acetate. U.S. Pat. Nos. 4,436,887, 4,495,313, 4,889,664, 5,006,622, 5,039459, 5,236,969, 5,270,418, 5,298,533, 5,824,719, 6,420,453, 6,423,761, 6,767,979, 7,934,830, 8,138,290, and 8,389,597 disclose the formation of conventional hydrogels. Commercially available conventional hydrogels include, but are not limited to, etafilcon, genfilcon, hilafilcon, lenefilcon, nesofilcon, omafilcon, polymacon, and vifilcon, including all of their variants.

“Silicone hydrogels” refer to polymeric networks made from at least one hydrophilic component and at least one silicone-containing component. Examples of silicone hydrogels include acquafilcon, asmofilcon, balafilcon, comfilcon, delefilcon, enfilcon, falcon, fanfilcon, formofilcon, galyfilcon, lotrafilcon, narafilcon, riofilcon, samfilcon, senofilcon, somofilcon, and stenfilcon, including all of their variants, as well as silicone hydrogels as prepared in U.S. Pat. Nos. 4,659,782, 4,659,783, 5,244,981, 5,314,960, 5,331,067, 5,371,147, 5,998,498, 6,087,415, 5,760,100, 5,776,999, 5,789,461, 5,849,811, 5,965,631, 6,367,929, 6,822,016, 6,867,245, 6,943,203, 7,247,692, 7,249,848, 7,553,880, 7,666,921, 7,786,185, 7,956,131, 8,022,158, 8,273,802, 8,399,538, 8,470,906, 8,450,387, 8,487,058, 8,507,577, 8,637,621, 8,703,891, 8,937,110, 8,937,111, 8,940,812, 9,056,878, 9,057,821, 9,125,808, 9,140,825, 9156,934, 9,170,349, 9,244,196, 9,244,197, 9,260,544, 9,297,928, 9,297,929 as well as WO 03/22321, WO 2008/061992, and US 2010/0048847. These patents are hereby incorporated by reference in their entireties.

An “interpenetrating polymeric network” comprises two or more networks which are at least partially interlaced on the molecular scale but not covalently bonded to each other and which cannot be separated without braking chemical bonds. A “semi-interpenetrating polymeric network” comprises one or more networks and one or more polymers characterized by some mixing on the molecular level between at least one network and at least one polymer. A mixture of different polymers is a “polymer blend.” A semi-interpenetrating network is technically a polymer blend, but in some cases, the polymers are so entangled that they cannot be readily removed.

The terms “reactive mixture” and “reactive monomer mixture” refer to the mixture of components (both reactive and non-reactive) which are mixed together and when subjected to polymerization conditions form the conventional or silicone hydrogels of the present invention as well as contact lenses made therefrom. The reactive monomer mixture may comprise reactive components such as the monomers, macromers, prepolymers, cross-linkers, and initiators, additives such as wetting agents, release agents, polymers, dyes, light absorbing compounds such as UV absorbers, pigments, dyes and photochromic compounds, any of which may be reactive or non-reactive but are capable of being retained within the resulting biomedical device, as well as pharmaceutical and nutraceutical compounds, and any diluents. It will be appreciated that a wide range of additives may be added based upon the biomedical device which is made and its intended use. Concentrations of components of the reactive mixture are expressed as weight percentages of all components in the reactive mixture, excluding diluent. When diluents are used, their concentrations are expressed as weight percentages based upon the amount of all components in the reactive mixture and the diluent.

“Reactive components” are the components in the reactive mixture which become part of the chemical structure of the polymeric network of the resulting hydrogel by covalent bonding, hydrogen bonding, electrostatic interactions, the formation of interpenetrating polymeric networks, or any other means.

The term “silicone hydrogel contact lens” refers to a hydrogel contact lens comprising at least one silicone containing component. Silicone hydrogel contact lenses generally have increased oxygen permeability compared to conventional hydrogels. Silicone hydrogel contact lenses use both their water and polymer content to transmit oxygen to the eye.

The term “multi-functional” refers to a component having two or more polymerizable groups. The term “mono-functional” refers to a component having one polymerizable group.

The terms “halogen” or “halo” indicate fluorine, chlorine, bromine, and iodine.

As used herein, the term “alkyl” refers to an unsubstituted or substituted linear or branched alkyl group containing the indicated number of carbon atoms. If no number is indicated, then alkyl (optionally including any substituents on alkyl) may contain 1 to 16 carbon atoms. Preferably, the alkyl group contains 1 to 10 carbon atoms, alternatively 1 to 7 carbon atoms, or alternatively 1 to 4 carbon atoms. Examples of alkyl include methyl, ethyl, propyl, isopropyl, butyl, iso-, sec- and tert-butyl, pentyl, hexyl, heptyl, 3-ethylbutyl, and the like. Examples of substituents on alkyl include 1, 2, or 3 groups independently selected from hydroxy, amino, amido, oxa, carboxy, alkyl carboxy, carbonyl, alkoxy, amido, carbamate, carbonate, halogen, phenyl, benzyl, and combinations thereof “Alkylene” means a divalent alkyl group, such as —CH₂—, —CH₂CH₂—, —CH₂CH₂CH₂—, —CH₂CH(CH₃)CH₂—, and —CH₂CH₂CH₂CH₂—.

“Haloalkyl” refers to an alkyl group as defined above substituted with one or more halogen atoms, where each halogen is independently F, Cl, Br or I. A preferred halogen is F. Preferred haloalkyl groups contain 1-6 carbons, more preferably 1-4 carbons, and still more preferably 1-2 carbons. “Haloalkyl” includes perhaloalkyl groups, such as —CF₃— or —CF₂CF₃—. “Haloalkylene” means a divalent haloalkyl group, such as —CH₂CF₂—.

“Cycloalkyl” refers to an unsubstituted or substituted cyclic hydrocarbon containing the indicated number of ring carbon atoms. If no number is indicated, then cycloalkyl may contain 3 to 12 ring carbon atoms. Preferred are C₃-C₈ cycloalkyl groups, C₃-C₇ cycloalkyl, more preferably C₄-C₇ cycloalkyl, and still more preferably C₅-C₆ cycloalkyl. Examples of cycloalkyl include cyclopropyl, cyclobutyl, cyclopentyl, cyclohexyl, cycloheptyl and cyclooctyl. Examples of substituents on cycloalkyl include 1, 2, or 3 groups independently selected from alkyl, hydroxy, amino, amido, oxa, carbonyl, alkoxy, amido, carbamate, carbonate, halo, phenyl, benzyl, and combinations thereof. “Cycloalkylene” means a divalent cycloalkyl group, such as 1,2-cyclohexylene, 1,3-cyclohexylene, or 1,4-cyclohexylene.

“Heterocycloalkyl” refers to a cycloalkyl ring or ring system as defined above in which at least one ring carbon has been replaced with a heteroatom selected from nitrogen, oxygen, and sulfur. The heterocycloalkyl ring is optionally fused to or otherwise attached to other heterocycloalkyl rings and/or non-aromatic hydrocarbon rings and/or phenyl rings. Preferred heterocycloalkyl groups have from 5 to 7 members. More preferred heterocycloalkyl groups have 5 or 6 members. Heterocycloalkylene means a divalent heterocycloalkyl group.

“Aryl” refers to an unsubstituted or substituted aromatic hydrocarbon ring system containing at least one aromatic ring. The aryl group contains the indicated number of ring carbon atoms. If no number is indicated, then aryl may contain 6 to 14 ring carbon atoms. The aromatic ring may optionally be fused or otherwise attached to other aromatic hydrocarbon rings or non-aromatic hydrocarbon rings. Examples of aryl groups include phenyl, naphthyl, and biphenyl. Preferred examples of aryl groups include phenyl. Examples of substituents on aryl include 1, 2, or 3 groups independently selected from alkyl, hydroxy, amino, amido, oxa, carboxy, alkyl carboxy, carbonyl, alkoxy, amido, carbamate, carbonate, halo, phenyl, benzyl, and combinations thereof. “Arylene” means a divalent aryl group, for example 1,2-phenylene, 1,3-phenylene, or 1,4-phenylene.

“Heteroaryl” refers to an aryl ring or ring system, as defined above, in which at least one ring carbon atom has been replaced with a heteroatom selected from nitrogen, oxygen, and sulfur. The heteroaryl ring may be fused or otherwise attached to one or more heteroaryl rings, aromatic or nonaromatic hydrocarbon rings or heterocycloalkyl rings. Examples of heteroaryl groups include pyridyl, furyl, and thienyl. “Heteroarylene” means a divalent heteroaryl group.

“Alkoxy” refers to an alkyl group attached to the parent molecular moiety through an oxygen bridge. Examples of alkoxy groups include, for instance, methoxy, ethoxy, propoxy and isopropoxy. “Aryloxy” refers to an aryl group attached to a parent molecular moiety through an oxygen bridge. Examples include phenoxy. “Cyclic alkoxy” means a cycloalkyl group attached to the parent moiety through an oxygen bridge.

“Alkylamine” refers to an alkyl group attached to the parent molecular moiety through an —NH bridge. Alkyleneamine means a divalent alkylamine group, such as —CH₂CH₂NH—.

“Siloxanyl” refers to a structure having at least one Si—O—Si bond. Thus, for example, siloxanyl group means a group having at least one Si—O—Si group (i.e. a siloxane group), and siloxanyl compound means a compound having at least one Si—O—Si group. “Siloxanyl” encompasses monomeric (e.g., Si—O—Si) as well as oligomeric/polymeric structures (e.g., —[Si—O]ₙ—, where n is 2 or more). Each silicon atom in the siloxanyl group is substituted with independently selected R^{A} groups (where R^{A} is as defined in formula A options (b)-(i)) to complete their valence.

“Silyl” refers to a structure of formula R₃Si- and “siloxy” refers to a structure of formula R₃Si—O—, where each R in silyl or siloxy is independently selected from trimethylsiloxy, C₁-C₈ alkyl (preferably C₁-C₃ alkyl, more preferably ethyl or methyl), and C₃-C₈ cycloalkyl.

“Alkyleneoxy” refers to groups of the general formula -(alkylene-O)ₚ- or -(O-alkylene)ₚ-, wherein alkylene is as defined above, and p is from 1 to 200, or from 1 to 100, or from 1 to 50, or from 1 to 25, or from 1 to 20, or from 1 to 10, wherein each alkylene is independently optionally substituted with one or more groups independently selected from hydroxyl, halo (e.g., fluoro), amino, amido, ether, carbonyl, carboxyl, and combinations thereof. If p is greater than 1, then each alkylene may be the same or different and the alkyleneoxy may be in block or random configuration. When alkyleneoxy forms a terminal group in a molecule, the terminal end of the alkyleneoxy may, for instance, be a hydroxy or alkoxy (e.g., HO—[CH₂CH₂O]ₚ— or CH₃O—[CH₂CH₂O]ₚ—). Examples of alkyleneoxy include polymethyleneoxy, polyethyleneoxy, polypropyleneoxy, polybutyleneoxy, and poly(ethyleneoxy-co-propyleneoxy).

“Oxaalkylene” refers to an alkylene group as defined above where one or more non-adjacent CH₂ groups have been substituted with an oxygen atom, such as —CH₂CH₂OCH(CH₃)CH₂—. “Thiaalkylene” refers to an alkylene group as defined above where one or more non-adjacent CH₂ groups have been substituted with a sulfur atom, such as —CH₂CH₂SCH(CH₃)CH₂—.

The term “linking group” refers to a moiety that links the polymerizable group to the parent molecule. The linking group may be any moiety that does not undesirably interfere with the polymerization of the compound of which it is a part. For instance, the linking group may be a bond, or it may comprise one or more alkylene, haloalkylene, amide, amine, alkyleneamine, carbamate, carboxylate (—Co₂—), arylene, heteroarylene, cycloalkylene, heterocycloalkylene, alkyleneoxy, oxaalkylene, thiaalkylene, haloalkyleneoxy (alkyleneoxy substituted with one or more halo groups, e.g., —OCF₂—, —OCF₂CF₂—, —OCF₂CH₂—), siloxanyl, alkylenesiloxanyl, or combinations thereof. The linking group may optionally be substituted with 1 or more substituent groups. Suitable substituent groups may include those independently selected from alkyl, halo (e.g., fluoro), hydroxyl, HO-alkyleneoxy, CH₃O-alkyleneoxy, siloxanyl, siloxy, siloxy-alkyleneoxy-, siloxy-alkylene-alkyleneoxy- (where more than one alkyleneoxy groups may be present and wherein each methylene in alkylene and alkyleneoxy is independently optionally substituted with hydroxyl), ether, amine, carbonyl, carbamate, and combinations thereof. The linking group may also be substituted with a polymerizable group, such as (meth)acrylate (in addition to the polymerizable group to which the linking group is linked).

Preferred linking groups include C₁-C₈ alkylene (preferably C₂-C₆ alkylene) and C₁-C₈ oxaalkylene (preferably C₂-C₆ oxaalkylene), each of which is optionally substituted with 1 or 2 groups independently selected from hydroxyl and siloxy. Preferred linking groups also include carboxylate, amide, C₁-C₈ alkylene-carboxylate-C₁-C₈ alkylene, or C₁-C₈ alkylene-amide-C₁-C₈ alkylene.

When the linking group is comprised of combinations of moieties as described above (e.g., alkylene and cycloalkylene), the moieties may be present in any order. For instance, if in Formula E below, L is indicated as being -alkylene-cycloalkylene-, then Rg-L may be either Rg-alkylene-cycloalkylene-, or Rg-cycloalkylene-alkylene-. Notwithstanding this, the listing order represents the preferred order in which the moieties appear in the compound starting from the terminal polymerizable group (Rg) to which the linking group is attached. For example, if in Formula E, L and L² are indicated as both being alkylene-cycloalkylene, then Rg-L is preferably Rg-alkylene-cycloalkylene- and -L²-Rg is preferably -cycloalkylene-alkylene-Rg.

The terms “blue-light blocking” or “blue-light absorbing” refer to particles that absorb, scatter, and/or extinguish incident light within the blue region of the electromagnetic spectrum (e.g., between 400 nm and 500 nm). Thus, the terms “blue-light blocking” or “blue-light absorbing” encompass particles that absorb, scatter, and/or extinguish incident light within the blue and violet region. The particles can be incorporated in varying quantities within an optically transparent substrate to achieve an optically transparent material which exhibits a desired level of blue-light blocking at one or more wavelengths within the blue region. The percent blocking at a particular wavelength can be determined from the material's transmission spectrum, where blocking=100−percent transmission (% T).

In some embodiments, optically transparent materials comprising the particles described herein can block at least 10%, at least 15%, at least 20%, at least 25%, at least 30%, at least 40%, at least 45%, at least 50%, at least 60%, at least 70%, at least 75%, at least 80%, or at least 90% of the incident light at one or more wavelengths of from 400 nm to 500 nm (e.g., one or more wavelengths between e.g., from 400 nm to 460 nm). In some embodiments, optically transparent materials comprising the particles described herein can block less than 20%, less than 15%, less than 10%, or less than 5% of the incident light at all wavelengths ranging from 520 nm to 700 nm. By blocking light in the blue light while significantly transmitting light in the visible range above 520 nm, the materials can be used in ophthalmic applications. If desired, additional filters can be incorporated into the optically transparent substrate to absorb, scatter, and/or extinguish wavelengths below 400 nm (e.g., UVA and/or UVB radiation), to absorb, scatter, and/or extinguish wavelengths above 500 nm (e.g., between 500 nm and 700 nm). For example, additional filters and/or dyes can be incorporated into the lens to provide color balancing. The degree of blocking can also be provided as a percentage for a particular wavelength range. In such cases, it is to be understood that the material exhibits the percent blocking at all wavelengths within that range.

“Nanoparticle” as used herein refers to a microscopic particle having at least one dimension that is less than 100 nm. In some cases, nanoparticles can have at least one dimension less than 50 nm. “Plasmonic nanoparticle” as used herein refers to a metal nanoparticle that has a strong absorption (and scattering) spectrum that is tunable by changing the shape, the composition or the medium around the particle surface. It will be appreciated that the term includes all plasmonic nanoparticles of various shapes that gives rise to a surface plasmon absorption and scattering spectrum in the blue region of the electromagnetic spectrum (e.g., between 400 nm and 500 nm).

“Surface plasmon” or “surface plasmon resonance” as used herein refers to resonant oscillations of oscillating electric fields of a ray of light propagating near a colloidal nanoparticle that interact with the free electrons thus causing an oscillation of electron charge that is in resonance with the frequency of visible light.

“Tuning” as used herein refers to changing the size, shape, surface chemistry or aggregation state of a nanoparticle in order to optimize the optical and electronic properties of the nanoparticle to a particular application. The plasmonic peak can be tuned to any wavelength by a suitable design of the nanoparticles as discussed in U.S. Pat. No. 9,005,890, herein incorporated in its entirety by reference.

Unless otherwise indicated, ratios, percentages, parts, and the like are by weight.

Unless otherwise indicated, numeric ranges, for instance as in “from 2 to 10,” are inclusive of the numbers defining the range (e.g., 2 and 10).

### Core-Shell Particles

Core-shell particles include a plasmonic nanoparticle core comprising a noble metal (e.g., silver); and a shell comprising a dielectric material surrounding the plasmonic nanoparticle core.

The size and shape of the plasmonic nanoparticle core can be varied to tune the optical properties of the core-shell particles. In some embodiments, the plasmonic nanoparticle cores can have a polyhedral shape. For example, the plasmonic nanoparticle cores can have a cubic shape, an octahedral shape, a decahedral shape, a cuboctahedral shape, a tetrahedral shape, a rhombic dodecahedral shape, a truncated ditetragonal prismatic shape, or a truncated bitetrahedral shape. In other embodiments, plasmonic nanoparticle cores can have a spherical shape.

The shape of the plasmonic nanoparticle cores can vary. In some embodiments, the plasmonic nanoparticle cores can have a polyhedral shape. For example, the plasmonic nanoparticle cores can have a cubic shape, an octahedral shape, a decahedral shape, a cuboctahedral shape, a tetrahedral shape, a rhombic dodecahedral shape, a truncated ditetragonal prismatic shape, or a truncated bitetrahedral shape.

In some cases, the plasmonic nanoparticle cores can have a homogenous particle shape. In these embodiments, substantially all of the plasmonic nanoparticles cores (e.g., at least 90%, at least 95%, or at least 98% of the plasmonic nanoparticles cores) can have the same particle shape. In other cases, the plasmonic nanoparticle cores can comprise a mixture of particle shapes (e.g., a mixture of two, three, four, five, six, seven, or more different particle shapes with the population of plasmonic nanoparticle cores). For example, in some examples, the plasmonic nanoparticle cores comprise a first population of plasmonic nanoparticle cores having a cubic shape and a second population of plasmonic nanoparticle cores having an octahedral shape.

The plasmonic nanoparticle core can have an average particle size. “Average particle size” and “mean particle size” are used interchangeably herein, and generally refer to the statistical mean particle size of the nanoparticles in a population of nanoparticles. For a nanoparticle core with a substantially spherical shape, the diameter of a nanoparticle can refer, for example, to the hydrodynamic diameter. As used herein, the hydrodynamic diameter of a particle can refer to the largest linear distance between two points on the surface of the particle. For nanoparticle cores having non-spherical shapes, the diameter of a nanoparticle can refer, for example, to the smallest cross-sectional dimension of the nanoparticle (i.e., the smallest linear distance passing through the center of the nanoparticle and intersecting two points on the surface of the particle). Mean particle size can be measured using methods known in the art, such as evaluation by scanning electron microscopy, transmission electron microscopy, and/or dynamic light scattering.

In some embodiments, the plasmonic nanoparticle cores of the core-shell particles can have an average particle size of at least 5 nm (e.g., at least 10 nm, at least 15 nm, at least 20 nm, at least 25 nm, at least 30 nm, at least 35 nm, at least 40 nm, at least 45 nm, at least 50 nm, at least 55 nm, at least 60 nm, at least 65 nm, at least 70 nm, at least 75 nm, at least 80 nm, at least 85 nm, at least 90 nm, or at least 95 nm), as measured by transmission electron microscopy (TEM). In some embodiments, the plasmonic nanoparticle cores of the core-shell particles can have an average particle size of 100 nm or less (e.g., 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, 15 nm or less, or 10 nm or less), as measured by transmission electron microscopy (TEM).

The plasmonic nanoparticle cores of the core-shell particles can have an average particle size ranging from any of the minimum values described above to any of the maximum values described above. For example, in some embodiments, the plasmonic nanoparticle cores of the core-shell particles can have an average particle size of from 5 nm to 100 nm (e.g., from 20 nm to 60 nm), as measured by transmission electron microscopy (TEM).

In some cases, the plasmonic nanoparticle cores have a monodisperse particle size distribution. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the mean particle size (e.g., within 20% of the mean particle size, within 15% of the mean particle size, within 10% of the mean particle size, or within 5% of the mean particle size). In other cases, the plasmonic nanoparticle cores have a polydisperse or heterogeneous particle size distribution.

The composition and dimension of the dielectric shell can also be varied. Appropriate composition and dimension can be selected in view of a number of considerations. For example, the dielectric shell can be selected to have an appropriate dielectric constant and thickness so as to minimize the interaction between adjacent plasmonic nanoparticle cores, preventing broadening and/or redshifting of absorbance and/or scattering peak of the plasmonic nanoparticle cores. This can provide for relatively narrow filters. In some embodiments, the dielectric shell can have a thickness greater than 50% (e.g., greater than 60%, greater than 70%, greater than 80%, or greater than 90%) of the average particle size of the plasmonic nanoparticle cores of the core-shell particles. In some embodiments, the dielectric shell can have a thickness greater than the average particle size of the plasmonic nanoparticle cores of the core-shell particles.

In some embodiments, the dielectric shell can be selected to possess a suitable refractive index for use in a particular application. Generally speaking, dielectrics with higher refractive indices produce a greater redshift in the plasmonic peak (generally with little to no peak broadening). Thus, the selection of an appropriate dielectric layer can also provide an avenue for tuning the absorption of the core-shell particles.

In some embodiments, the dielectric shell can be selected to possess suitable compatibility with an optically transparent material into which the core-shell particles are to be introduced. For example, the dielectric shell can be selected to have a hydrophobicity or hydrophilicty which matches the hydrophobicity or hydrophilicty of the optically transparent material into which the core-shell particles are to be introduced.

The dielectric layer can be formed from any suitable dielectric material. Examples of suitable dielectric materials include inorganic materials such as, for example, silicon dioxide, silicon nitride, diamond-like carbon, titanium dioxide, titanium nitride, iron oxide, zinc oxide, aluminum oxide, copper oxide, and aluminum nitride. In certain embodiments, dielectric layer can comprise silicon dioxide. When the dielectric layer is formed from silicon dioxide (SiO₂), the dielectric layer can also be referred to as a “silica shell.”

Organic (generally oligomeric or polymeric) dielectric can also be used, such as ethylene glycol oligomers, poly(ethylene glycol) (PEG), poly(vinyl alcohol) (PVA), polyvinylpyrrolidone (PVP), polystyrene (PS), polycaprolactone (PCL), ethylene oligomers or polyethylene (PE), polypropylene (PP), poly(methyl methacrylate) (PMMA) and silicone, as well as copolymers or blends thereof. Organic macromolecules, such as those described above, can either (1) directly adsorb onto, or have a portion that directly adsorb onto, the plasmonic nanoparticle core or (2) have one or more functional group(s), such as a thiol, that links them to the plasmonic nanoparticle core.

If desired, the dielectric shell can be selected (or chemically functionalized) to enhance dispersability of the core-shell matrix within an optically transparent substrate, such as a silicone hydrogel. In addition, functionalization can give the dielectrics charge, change the surface refractive index, change the hydrophobic/hydrophilic character, etc.

Some dielectrics naturally have functional groups exposed (carboxylates, amines, alcohols, etc.). For example, many organic dielectrics terminate in alcohol or carboxylate groups. Silicon dioxide terminates in alcohol groups. These functional groups can be conjugated to directly or an intermediate linker can provide additional moieties to broaden the chemistry of the core-shell particles. As an example of an intermediate linker, 3-(aminopropyl)triethoxysilane (APTES) can functionalize silicon dioxide to provide an amine group, which enables a diverse selection of chemistries (e.g., amide bond formation) of varying facileness, strengths, permanence and reactivities.

For integration into a polymeric material, it can be desirable that the core-shell particles present (e.g., the dielectric can be modified to present) a functional group that polymerizes with that polymer. For example, a methacrylate group can enable covalent linking to the matrix during UV curing of an etafilcon A lens.

In some embodiments, the shells of the core-shell particles can have an average thickness of at least 1 nm (e.g., at least 2 nm, at least 3 nm, at least 4 nm, at least 5 nm, at least 6 nm, at least 7 nm, at least 8 nm, at least 9 nm, at least 10 nm, at least 15 nm, at least 20 nm, at least 25 nm, at least 30 nm, at least 35 nm, at least 40 nm, at least 45 nm, at least 50 nm, at least 55 nm, at least 60 nm, at least 65 nm, at least 70 nm, at least 75 nm, at least 80 nm, at least 85 nm, at least 90 nm, or at least 95 nm), as measured by transmission electron microscopy (TEM). In some embodiments, the shells of the core-shell particles can have an average thickness of 100 nm or less (e.g., 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, 5 nm or less, 4 nm or less, 3 nm or less, or 2 nm or less), as measured by transmission electron microscopy (TEM).

The shells of the core-shell particles can have an average thickness ranging from any of the minimum values described above to any of the maximum values described above. For example, in some embodiments, the shells of the core-shell particles can have an average thickness of from 1 nm to 100 nm (e.g., from 15 nm to 50 nm), as measured by transmission electron microscopy (TEM).

In some embodiments, the plasmonic nanoparticle cores of the core-shell particles can have an average particle size, the shells of the core-shell particles can have an average thickness, and the ratio of the average particle size to the average thickness can be at least 1:5 (e.g., at least 1:4, at least 1:3, at least 1:2, at least 2:3, at least 1:1, at least 1.5:1, at least 2:1, at least 2.5:1, at least 3:1, at least 4:1, at least 5:1, at least 6:1, at least 7:1, at least 8:1, at least 9:1, at least 10:1, or at least 15:1), as measured by transmission electron microscopy (TEM). In some embodiments, the ratio of the average particle size to the average thickness can be 20:1 or less (e.g., 15:1 or less, 10:1 or less, 9:1 or less, 8:1 or less, 7:1 or less, 6:1 or less, 5:1 or less, 4:1 or less, 3:1 or less, 2.5:1 or less, 2:1 or less, 1.5:1 or less, 1:1 or less, 2:3 or less, 1:2 or less, 1:3 or less, 1:4 or less), as measured by transmission electron microscopy (TEM).

The ratio of the average particle size to the average thickness can range from any of the minimum values described above to any of the maximum values described above. For example, in some embodiments, the ratio of the average particle size to the average thickness can be from 1:5 to 20:1 (e.g., from 2:3 to 6:1), as measured by transmission electron microscopy (TEM). In some embodiments, the core-shell particles can exhibit a maximum absorption value of at least 400 nm (e.g., at least 405 nm, at least 410 nm, at least 415 nm, at least 420 nm, at least 425 nm, at least 430 nm, at least 435 nm, at least 440 nm, at least 445 nm, at least 450 nm, at least 455 nm, at least 460 nm, at least 465 nm, at least 470 nm, at least 475 nm, at least 480 nm, at least 485 nm, at least 490 nm, or at least 495 nm). In some embodiments, the core-shell particles can exhibit a maximum absorption value of 500 nm or less (e.g., 495 nm or less, 490 nm or less, 485 nm or less, 480 nm or less, 475 nm or less, 470 nm or less, 465 nm or less, 460 nm or less, 455 nm or less, 450 nm or less, 445 nm or less, 440 nm or less, 435 nm or less, 430 nm or less, 425 nm or less, 420 nm or less, 415 nm or less, 410 nm or less, or 405 nm or less).

The core-shell particles can exhibit a maximum absorption value ranging from any of the minimum values described above to any of the maximum values described above. For example, in some embodiments, the core-shell particles can exhibit a maximum absorption value of from 400 nm to 500 nm (e.g., from 400 nm to 460 nm).

In some embodiments, the core-shell particles can exhibit an absorption spectrum having a full-width at half maximum of at least 20 nm (e.g., at least 25 nm, at least 30 nm, at least 35 nm, at least 40 nm, at least 45 nm, at least 50 nm, at least 55 nm, at least 60 nm, at least 65 nm, or at least 70 nm). In some embodiments, the core-shell particles can exhibit an absorption spectrum having a full-width at half maximum of 75 nm or less (e.g., 70 nm or less, 65 nm or less, 60 nm or less, 55 nm or less, 50 nm or less, 45 nm or less, 40 nm or less, 35 nm or less, 30 nm or less, or 25 nm or less).

The core-shell particles can exhibit an absorption spectrum having a full-width at half maximum ranging from any of the minimum values described above to any of the maximum values described above. For example, in some embodiments, the core-shell particles can exhibit an absorption spectrum having a full-width at half maximum of from 20 nm to 75 nm.

### Optically Transparent Materials

Populations of the core-shell particles described herein can be incorporated within an optically transparent substrate to form an optically transparent material. In some embodiments, the core-shell particles can be dispersed with the optically transparent substrate. In some embodiments, the core-shell particles can coated on

The substrate can comprise any suitable optically transparent material such as, for example, a glass, allyl diglycol carbonate (ADC), a polycarbonate, a polyurethane, a thiourethane, a poly(meth)acrylate, a silicone hydrogel, or a combination thereof.

The core-shell particles can be incorporated in the optically transparent substrate at varying concentrations. By way of example, in some embodiments, the population a population of core-shell particles can be present in the substrate at a concentration of from 0.01% by weight to 10% by weight (e.g., from 0.05% by weight to 10% by weight, from 0.1% by weight to 10% by weight, from 0.5% by weight to 10% by weight, from 0.01% by weight to 5% by weight, from 0.05% by weight to 5% by weight, from 0.1% by weight to 5% by weight, from 0.5% by weight to 5% by weight, from 0.01% by weight to 2.5% by weight, from 0.05% by weight to 2.5% by weight, from 0.1% by weight to 2.5% by weight, or from 0.5% by weight to 2.5% by weight), based on the total weight of the substrate.

The core-shell particles can be uniformly dispersed throughout the optically transparent substrate material. Alternatively, the core-shell particles can be dispersed, coated, or deposited on the surface the optically transparent substrate material. If desired, the core-shell particles can be patterned on and/or within the optically transparent substrate material (e.g., in the form of letters, numbers, shapes, logos, etc.) to generate a material having regions through which incident light is filtered by the core-shell particles and regions through which incident light passes unfiltered.

In some embodiments, the optically transparent material can comprise hydrogel or silicone hydrogel material suitable for use in the formation of a soft contact lens. Such materials are known in the art and include Group 1—Low Water (<50% H₂O) Nonionic Hydrogel Polymers (e.g., tefilcon, tetrafilcon A, crofilcon, helfilcon A, helfilcon B, mafilcon, polymacon, hioxifilcon B); Group 2—High Water (>50% H₂O) Nonionic Hydrogel Polymers (e.g., surfilcon A, lidofilcon A, lidofilcon B, netrafilcon A, hefilcon B, alphafilcon A, omafilcon A, omafilcon B, vasurfilcon A, hioxifilcon A, hioxifilcon D, nelfilcon A, hilafilcon A, hilafilcon B, acofilcon A, nesofilcon A); Group 3—Low Water (<50% H₂O) Ionic Hydrogel Polymers (e.g., bufilcon A, deltafilcon A, phemfilcon); Group 4—High Water (>50% H₂O) Ionic Hydrogel Polymers (e.g., bufilcon A, perfilcon A, etafilcon A, focofilcon A, ocufilcon A, ocufilcon B, ocufilcon C, ocufilcon D, ocufilcon E, ocufilcon F, phemfilcon A, methafilcon A, methafilcon B, vilfilcon A); and Silicone Hydrogel Polymers (e.g., lotrafilcon A, lotrafilcon B, galyfilcon A, senofilcon A, senofilcon C, sifilcon A, comfilcon A, enfilcon A, balafilcon A, delefilcon A, narafilcon B, narafilcon A, stenfilcon A, somofilcon A, fanfilcon A, samfilcon A, elastofilcon).

In some embodiments, the substrate can comprise a silicone hydrogel. In certain embodiments, the substrate can comprise a polymer derived from polymerization of a reactive mixture that includes a hydrophilic monomer, a silicone-containing component, or combinations thereof. Example silicone hydrogel substrates include those discussed in detail below.

### Devices

The resulting optically transparent materials can be used to form a variety of different articles, including optical lenses (e.g., eyeglass lenses, camera lenses, contact lenses, etc.), ophthalmic devices (e.g., contact lenses, corneal onlays, corneal inlays, intraocular lenses, overlay lenses, etc.), screen covers (e.g., a transparent sheet configured to cover a computer monitor, tablet screen, or cell phone screen), and housings for electronic devices having LED displays. Accordingly, also provided are optical lenses (e.g., eyeglass lenses, camera lenses, contact lenses, etc.), ophthalmic devices (e.g., contact lenses, corneal onlays, corneal inlays, intraocular lenses, overlay lenses, etc.), screen covers (e.g., a transparent sheet configured to cover a computer monitor, tablet screen, or cell phone screen), and housings for electronic devices having LED displays which are formed at whole or in part from the optically transparent materials described herein.

A variety of ophthalmic devices containing the core-shell particles described herein may be prepared, including hard contact lenses, soft contact lenses, corneal onlays, corneal inlays, intraocular lenses, or overlay lenses. Preferably, the ophthalmic device is a soft contact lens, which may be made from conventional or silicone hydrogel formulations.

Ophthalmic devices may be prepared by polymerizing a reactive mixture containing a population of the core-shell particles described herein, one or more monomers suitable for making the desired ophthalmic device, and optional components. In some cases, the reactive mixture may include, in addition to a population of the core-shell particles described above, one or more of: hydrophilic components, hydrophobic components, silicone-containing components, wetting agents such as polyamides, crosslinking agents, and further components such as diluents and initiators.

### Hydrophilic Components

Examples of suitable families of hydrophilic monomers include (meth)acrylates, styrenes, vinyl ethers, (meth)acrylamides, N-vinyl lactams, N-vinyl amides, N-vinyl imides, N-vinyl ureas, O-vinyl carbamates, O-vinyl carbonates, other hydrophilic vinyl compounds, and mixtures thereof.

Non-limiting examples of hydrophilic (meth)acrylate and (meth)acrylamide monomers include: acrylamide, N-isopropyl acrylamide, N,N-dimethylaminopropyl (meth)acrylamide,

N,N-dimethyl acrylamide (DMA), 2-hydroxyethyl methacrylate (HEMA), 2-hydroxypropyl (meth)acrylate, 3-hydroxypropyl (meth)acrylate, 2,3-dihydroxypropyl (meth)acrylate, 2-hydroxybutyl (meth)acrylate, 3-hydroxybutyl (meth)acrylate, 4-hydroxybutyl (meth)acrylate, N-(2-hydroxyethyl) (meth)acrylamide, N,N-bis(2-hydroxyethyl) (meth)acrylamide, N-(2-hydroxypropyl) (meth)acrylamide, N,N-bis(2-hydroxypropyl) (meth)acrylamide, N-(3-hydroxypropyl) (meth)acrylamide, N-(2-hydroxybutyl) (meth)acrylamide, N-(3-hydroxybutyl) (meth)acrylamide, N-(4-hydroxybutyl) (meth)acrylamide, 2-aminoethyl (meth)acrylate, 3-aminopropyl (meth)acrylate, 2-aminopropyl (meth)acrylate, N-2-aminoethyl (meth)acrylamides), N-3-aminopropyl (meth)acrylamide, N-2-aminopropyl (meth)acrylamide, N,N-bis-2-aminoethyl (meth)acrylamides, N,N-bis-3-aminopropyl (meth)acrylamide), N,N-bis-2-aminopropyl (meth)acrylamide, glycerol methacrylate, polyethyleneglycol monomethacrylate, (meth)acrylic acid, vinyl acetate, acrylonitrile, and mixtures thereof.

Hydrophilic monomers may also be ionic, including anionic, cationic, zwitterions, betaines, and mixtures thereof. Non-limiting examples of such charged monomers include (meth)acrylic acid, N-[(ethenyloxy)carbonyl]-β-alanine (VINAL), 3-acrylamidopropanoic acid (ACA1), 5-acrylamidopentanoic acid (ACA2), 3-acrylamido-3-methylbutanoic acid (AMBA), 2-(methacryloyloxy)ethyl trimethylammonium chloride (Q Salt or METAC), 2-acrylamido-2-methylpropane sulfonic acid (AMPS), 1-propanaminium, N-(2-carboxyethyl)-N,N-dimethyl-3-[(1-oxo-2-propen-1-yl)amino]-, inner salt (CBT), 1-propanaminium, N,N-dimethyl-N-[3-[(1-oxo-2-propen-1-yl)amino]propyl]-3-sulfo-, inner salt (SBT), 3,5-Dioxa-8-aza-4-phosphaundec-10-en-1-aminium, 4-hydroxy-N,N,N-trimethyl-9-oxo-, inner salt, 4-oxide (9CI) (PBT), 2-methacryloyloxyethyl phosphorylcholine, 3-(dimethyl(4-vinylbenzyl)ammonio)propane-1-sulfonate (DMVBAPS), 3-((3-acrylamidopropyl)dimethylammonio)propane-1-sulfonate (AMPDAPS), 3-((3-methacrylamidopropyl)dimethylammonio)propane-1-sulfonate (MAMPDAPS), 3-((3-(acryloyloxy)propyl)dimethylammonio)propane-1-sulfonate (APDAPS), and 3-((3-(methacryloyloxy)propyl)dimethylammonio)propane-1-sulfonate (MAPDAPS).

Non-limiting examples of hydrophilic N-vinyl lactam and N-vinyl amide monomers include: N-vinyl pyrrolidone (NVP), N-vinyl-2-piperidone, N-vinyl-2-caprolactam, N-vinyl-3-methyl-2-caprolactam, N-vinyl-3-methyl-2-piperidone, N-vinyl-4-methyl-2-piperidone, N-vinyl-4-methyl-2-caprolactam, N-vinyl-3-ethyl-2-pyrrolidone, N-vinyl-4,5-dimethyl-2-pyrrolidone, N-vinyl acetamide (NVA), N-vinyl-N-methylacetamide (VMA), N-vinyl-N-ethyl acetamide, N-vinyl-N-ethyl formamide, N-vinyl formamide, N-vinyl-N-methylpropionamide, N-vinyl-N-methyl-2-methylpropionamide, N-vinyl-2-methylpropionamide, N-vinyl-N,N′-dimethylurea, 1-methyl-3-methylene-2-pyrrolidone, 1-methyl-5-methylene-2-pyrrolidone, 5-methyl-3-methylene-2-pyrrolidone; 1-ethyl-5-methylene-2-pyrrolidone, N-methyl-3-methylene-2-pyrrolidone, 5-ethyl-3-methylene-2-pyrrolidone, 1-N-propyl-3-methylene-2-pyrrolidone, 1-N-propyl-5-methylene-2-pyrrolidone, 1-isopropyl-3-methylene-2-pyrrolidone, 1-isopropyl-5-methylene-2-pyrrolidone, N-vinyl-N-ethyl acetamide, N-vinyl-N-ethyl formamide, N-vinyl formamide, N-vinyl isopropylamide, N-vinyl caprolactam, N-vinylimidazole, and mixtures thereof

Non-limiting examples of hydrophilic O-vinyl carbamates and O-vinyl carbonates monomers include N-2-hydroxyethyl vinyl carbamate and N-carboxy-B-alanine N-vinyl ester. Further examples of hydrophilic vinyl carbonate or vinyl carbamate monomers are disclosed in U.S. Pat. No. 5,070,215. Hydrophilic oxazolone monomers are disclosed in U.S. Pat. No. 4,910,277.

Other hydrophilic vinyl compounds include ethylene glycol vinyl ether (EGVE), di(ethylene glycol) vinyl ether (DEGVE), allyl alcohol, and 2-ethyl oxazoline.

The hydrophilic monomers may also be macromers or prepolymers of linear or branched poly(ethylene glycol), poly(propylene glycol), or statistically random or block copolymers of ethylene oxide and propylene oxide, having polymerizable moieties such as (meth)acrylates, styrenes, vinyl ethers, (meth)acrylamides, N-vinylamides, and the like. The macromers of these polyethers have one polymerizable group; the prepolymers may have two or more polymerizable groups.

The preferred hydrophilic monomers of the present invention are DMA, NVP, HEMA, VMA, NVA, and mixtures thereof. Other suitable hydrophilic monomers will be apparent to one skilled in the art.

Generally, there are no particular restrictions with respect to the amount of the hydrophilic monomer present in the reactive monomer mixture. The amount of the hydrophilic monomers may be selected based upon the desired characteristics of the resulting hydrogel, including water content, clarity, wettability, protein uptake, and the like. Wettability may be measured by contact angle, and desirable contact angles are less than about 100°, less than about 80°, and less than about 60°. The hydrophilic monomer may be present in an amount in the range of about 0.1 to about 80 weight percent, including in the range of about 5 to about 65 weight percent, and in the range of about 10 to about 45 weight percent, based on the total weight of the reactive components in the reactive monomer mixture.

### Silicone-Containing Components

Silicone-containing components suitable for use comprise one or more polymerizable compounds, where each compound independently comprises at least one polymerizable group, at least one siloxane group, and one or more linking groups connecting the polymerizable group(s) to the siloxane group(s). The silicone-containing components may, for instance, contain from 1 to 220 siloxane repeat units, such as the groups defined below. The silicone-containing component may also contain at least one fluorine atom.

The silicone-containing component may comprise: one or more polymerizable groups as defined above; one or more optionally repeating siloxane units; and one or more linking groups connecting the polymerizable groups to the siloxane units. The silicone-containing component may comprise: one or more polymerizable groups that are independently a (meth)acrylate, a styryl, a vinyl ether, a (meth)acrylamide, an N-vinyl lactam, an N-vinylamide, an O-vinylcarbamate, an O-vinylcarbonate, a vinyl group, or mixtures of the foregoing; one or more optionally repeating siloxane units; and one or more linking groups connecting the polymerizable groups to the siloxane units.

The silicone-containing component may comprise: one or more polymerizable groups that are independently a (meth)acrylate, a (meth)acrylamide, an N-vinyl lactam, an N-vinylamide, a styryl, or mixtures of the foregoing; one or more optionally repeating siloxane units; and one or more linking groups connecting the polymerizable groups to the siloxane units.

The silicone-containing component may comprise: one or more polymerizable groups that are independently a (meth)acrylate, a (meth)acrylamide, or mixtures of the foregoing; one or more optionally repeating siloxane units; and one or more linking groups connecting the polymerizable groups to the siloxane units.

Formula A. The silicone-containing component may comprise one or more polymerizable compounds of Formula A:

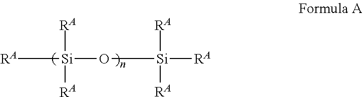

wherein:

at least one R^{A} is a group of formula R_{g}L wherein R_{g} is a polymerizable group and L is a linking group, and the remaining R^{A} are each independently:
(a) R_{g}-L-,
(b) C₁-C₁₆ alkyl optionally substituted with one or more hydroxy, amino, amido, oxa, carboxy, alkyl carboxy, carbonyl, alkoxy, amido, carbamate, carbonate, halo, phenyl, benzyl, or combinations thereof,
(c) C₃-C₁₂ cycloalkyl optionally substituted with one or more alkyl, hydroxy, amino, amido, oxa, carbonyl, alkoxy, amido, carbamate, carbonate, halo, phenyl, benzyl, or combinations thereof,
(d) a C₆-C₁₄ aryl group optionally substituted with one or more alkyl, hydroxy, amino, amido, oxa, carboxy, alkyl carboxy, carbonyl, alkoxy, amido, carbamate, carbonate, halo, phenyl, benzyl, or combinations thereof,
(e) halo,
(f) alkoxy, cyclic alkoxy, or aryloxy,
(g) siloxy,
(h) alkyleneoxy-alkyl or alkoxy-alkyleneoxy-alkyl, such as polyethyleneoxyalkyl, polypropyleneoxyalkyl, or poly(ethyleneoxy-co-propyleneoxyalkyl), or
(i) a monovalent siloxane chain comprising from 1 to 100 siloxane repeat units optionally substituted with alkyl, alkoxy, hydroxy, amino, oxa, carboxy, alkyl carboxy, alkoxy, amido, carbamate, halo or combinations thereof; and

n is from 0 to 500 or from 0 to 200, or from 0 to 100, or from 0 to 20, where it is understood that when n is other than 0, n is a distribution having a mode equal to a stated value. When n is 2 or more, the SiO units may carry the same or different R^{A} substituents and if different R^{A} substituents are present, the n groups may be in random or block configuration.

In Formula A, three R^{A} may each comprise a polymerizable group, alternatively two R^{A} may each comprise a polymerizable group, or alternatively one R^{A} may comprise a polymerizable group.

Formula B. The silicone-containing component of formula A may be a mono-functional polymerizable compound of formula B:

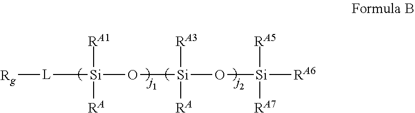

wherein:

Rg is a polymerizable group;

L is a linking group;

j1 and j2 are each independently whole numbers from 0 to 220, provided that the sum of j1 and j2 is from 1 to 220;

R^{A1}, R^{A2}, R^{A3}, R^{A4}, R^{A5}, and R^{A7} are independently at each occurrence C₁-C₆ alkyl, C₃-C₁₂ cycloalkyl, C₁-C₆ alkoxy, C₄-C₁₂ cyclic alkoxy, alkoxy-alkyleneoxy-alkyl, aryl (e.g., phenyl), aryl-alkyl (e.g., benzyl), haloalkyl (e.g., partially or fully fluorinated alkyl), siloxy, fluoro, or combinations thereof, wherein each alkyl in the foregoing groups is optionally substituted with one or more hydroxy, amino, amido, oxa, carboxy, alkyl carboxy, carbonyl, alkoxy, carbamate, carbonate, halo, phenyl, or benzyl, each cycloalkyl is optionally substituted with one or more alkyl, hydroxy, amino, amido, oxa, carbonyl, alkoxy, carbamate, carbonate, halo, phenyl, or benzyl and each aryl is optionally substituted with one or more alkyl, hydroxy, amino, amido, oxa, carboxy, alkyl carboxy, carbonyl, alkoxy, carbamate, carbonate, halo, phenyl, or benzyl; and

R^{A6} is siloxy, C₁-C₈ alkyl (e.g., C₁-C₄ alkyl, or butyl, or methyl), or aryl (e.g., phenyl), wherein alkyl and aryl may optionally be substituted with one or more fluorine atoms.

Formula B-1. Compounds of formula B may include compounds of formula B-1, which are compounds of formula B wherein j1 is zero and j2 is from 1 to 220, or j2 is from 1 to 100, or j2 is from 1 to 50, or j2 is from 1 to 20, or j2 is from 1 to 5, or j2 is 1.

B-2. Compounds of formula B may include compounds of formula B-2, which are compounds of formula B wherein j1 and j2 are independently from 4 to 100, or from 4 to 20, or from 4 to 10, or from 24 to 100, or from 10 to 100.

B-3. Compounds of formulae B, B-1, and B-2 may include compounds of formula B-3, which are compounds of formula B, B-1, or B-2 wherein R^{A1}, R^{A2}, R^{A3}, and R^{A4} are independently at each occurrence C₁-C₆ alkyl or siloxy. Preferred alkyl are C₁-C₃ alkyl, or more preferably, methyl. Preferred siloxy is trimethylsiloxy.

B-4. Compounds of formulae B, B-1, B-2, and B-3 may include compounds of formula B-4, which are compounds of formula B, B-1, B-2, or B-3 wherein R^{A5} and R^{A7} are independently alkoxy-alkyleneoxy-alkyl, preferably they are independently a methoxy capped polyethyleneoxyalkyl of formula CH₃O—[CH₂CH₂O]p-CH₂CH₂CH₂, wherein p is a whole number from 1 to 50.

B-5. Compounds of formulae B, B-1, B-2, and B-3 may include compounds of formula B-5, which are compounds of formula B, B-1, B-2, or B-3 wherein R^{A5} and R^{A7} are independently siloxy, such as trimethylsiloxy.

B-6. Compounds of formulae B, B-1, B-2, and B-3 may include compounds of formula B-6, which are compounds of formula B, B-1, B-2, or B-3 wherein R^{A5} and R^{A7} are independently C₁-C₆ alkyl, alternatively C₁-C₄ alkyl, or alternatively, butyl or methyl.

B-7. Compounds of formulae B, B-1, B-2, B-3, B-4, B-5, and B-6 may include compounds of formula B-7, which are compounds of formula B, B-1, B-2, B-3, B-4, B-5, or B-6 wherein R^{A6} is C₁-C₈ alkyl, preferably C₁-C₆ alkyl, more preferably C₁-C₄ alkyl (for example methyl, ethyl, n-propyl, or n-butyl). More preferably R^{A6} is n-butyl.

B-8. Compounds of formulae B, B-1, B-2, B-3, B-4, B-5, B-6, and B-7, may include compounds of formula B-8, which are compounds of formula B, B-1, B-2, B-3, B-4, B-5, B-6, or B-7 wherein Rg comprises styryl, vinyl carbonate, vinyl ether, vinyl carbamate, N-vinyl lactam, N-vinylamide, (meth)acrylate, or (meth)acrylamide. Preferably, Rg comprises (meth)acrylate, (meth)acrylamide, or styryl. More preferably, Rg comprises (meth)acrylate or (meth)acrylamide. When Rg is (meth)acrylamide, the nitrogen group may be substituted with R^{A9}, wherein R^{A9} is H, C₁-C₈ alkyl (preferably C₁-C₄ alkyl, such as n-butyl, n-propyl, methyl or ethyl), or C₃-C₈ cycloalkyl (preferably C₅-C₆ cycloalkyl), wherein alkyl and cycloalkyl are optionally substituted with one or more groups independently selected from hydroxyl, amide, ether, silyl (e.g., trimethylsilyl), siloxy (e.g., trimethylsiloxy), alkyl-siloxanyl (where alkyl is itself optionally substituted with fluoro), aryl-siloxanyl (where aryl is itself optionally substituted with fluoro), and silyl-oxaalkylene-(where the oxaalkylene is itself optionally substituted with hydroxyl).

B-9. Compounds of formulae B, B-1, B-2, B-3, B-4, B-5, B-6, B-7, and B-8 may include compounds of formula B-9, which are compounds of formula B, B-1, B-2, B-3, B-4, B-5, B-6, B-7, or B-8 wherein the linking group comprises alkylene (preferably C₁-C₄ alkylene), cycloalkylene (preferably C₅-C₆ cycloalkylene), alkyleneoxy (preferably ethyleneoxy), haloalkyleneoxy (preferably haloethyleneoxy), amide, oxaalkylene (preferably containing 3 to 6 carbon atoms), siloxanyl, alkylenesiloxanyl, carbamate, alkyleneamine (preferably C₁-C₆ alkyleneamine), or combinations of two or more thereof, wherein the linking group is optionally substituted with one or more substituents independently selected from alkyl, hydroxyl, ether, amine, carbonyl, siloxy, and carbamate.

B-10. Compounds of formulae B, B-1, B-2, B-3, B-4, B-5, B-6, B-7, B-8, and B-9 may include compounds of formula B-10, which are compounds of formula B, B-1, B-2, B-3, B-4, B-5, B-6, B-7, B-8, or B-9 wherein the linking group is alkylene-siloxanyl-alkylene-alkyleneoxy-, or alkylene-siloxanyl-alkylene-[alkyleneoxy-alkylene-siloxanyl]_{q}-alkyleneoxy-, where q is from 1 to 50.

B-11. Compounds of formulae B, B-1, B-2, B-3, B-4, B-5, B-6, B-7, B-8, and B-9 may include compounds of formula B-11, which are compounds of formula B, B-1, B-2, B-3, B-4, B-5, B-6, B-7, B-8, or B-9 wherein the linking group is C₁-C₆ alkylene, preferably C₁-C₃ alkylene, more preferably n-propylene.

B-12. Compounds of formulae B, B-1, B-2, B-3, B-4, B-5, B-6, B-7, B-8, and B-9 may include compounds of formula B-12, which are compounds of formula B, B-1, B-2, B-3, B-4, B-5, B-6, B-7, B-8, or B-9 wherein the linking group is alkylene-carbamate-oxaalkylene. Preferably, the linking group is CH₂CH₂N(H)—C(═O)—O—CH₂CH₂—O—CH₂CH₂CH₂.

B-13. Compounds of formulae B, B-1, B-2, B-3, B-4, B-5, B-6, B-7, B-8, and B-9 may include compounds of formula B-13, which are compounds of formula B, B-1, B-2, B-3, B-4, B-5, B-6, B-7, B-8, or B-9 wherein the linking group is oxaalkylene. Preferably, the linking group is CH₂CH₂—O—CH₂CH₂CH₂.

B-14. Compounds of formulae B, B-1, B-2, B-3, B-4, B-5, B-6, B-7, B-8, and B-9 may include compounds of formula B-14, which are compounds of formula B, B-1, B-2, B-3, B-4, B-5, B-6, B-7, B-8, or B-9 wherein the linking group is alkylene-[siloxanyl-alkylene]_{q}-, where q is from 1 to 50. An example of such a linking group is: —(CH₂)₃—[Si(CH₃)₂—O—Si(CH₃)₂—(CH₂)₂]_{q}—.

B-15. Compounds of formulae B, B-1, B-2, B-3, B-4, B-5, B-6, B-7, B-8, and B-9 may include compounds of formula B-15, which are compounds of formula B, B-1, B-2, B-3, B-4, B-5, B-6, B-7, B-8, or B-9 wherein the linking group is alkyleneoxy-carbamate-alkylene-cycloalkylene-carbamate-oxaalkylene, wherein cycloalkylene is optionally substituted with or 1, 2, or 3 independently selected alkyl groups (preferably C₁-C₃ alkyl, more preferably methyl). An example of such a linking group is —[OCH₂CH₂]_{q}—OC(═O)—NH—CH₂—[1,3-cyclohexylene]-NHC(═O)O—CH₂CH₂—O—CH₂CH₂—, wherein the cyclohexylene is substituted at the 1 and 5 positions with 3 methyl groups.

B-16. Compounds of formulae B, B-1, B-2, B-3, B-4, B-5, B-6, B-7, B-8, and B-9 may include compounds of formula B-16, which are compounds of formula B, B-1, B-2, B-3, B-4, B-5, B-6, B-7, B-8, or B-9 wherein Rg comprises styryl and the linking group is alkyleneoxy wherein each alkylene in alkyleneoxy is independently optionally substituted with hydroxyl. An example of such a linking group is —O—(CH₂)₃—. Another example of such a linking group is —O—CH₂CH(OH)CH₂—O—(CH₂)₃—.

B-17. Compounds of formulae B, B-1, B-2, B-3, B-4, B-5, B-6, B-7, B-8, and B-9 may include compounds of formula B-17, which are compounds of formula B, B-1, B-2, B-3, B-4, B-5, B-6, B-7, B-8, or B-9 wherein Rg comprises styryl and the linking group is alkyleneamine. An example of such a linking group is —NH—(CH₂)₃—.

B-18. Compounds of formulae B, B-1, B-2, B-3, B-4, B-5, B-6, B-7, B-8, and B-9 may include compounds of formula B-18, which are compounds of formula B, B-1, B-2, B-3, B-4, B-5, B-6, B-7, B-8, or B-9 wherein the linking group is oxaalkylene optionally substituted with hydroxyl, siloxy, or silyl-alkyleneoxy (where the alkyleneoxy is itself optionally substituted with hydroxyl). An example of such a linking group is —CH₂CH(G)CH₂—O—(CH₂)₃—, wherein G is hydroxyl. In another example, G is R₃SiO— wherein two R groups are trimethylsiloxy and the third is C₁-C₈ alkyl (preferably C₁-C₃ alkyl, more preferably methyl) or the third is C₃-C₈ cycloalkyl. In a further example, G is R₃Si—(CH₂)₃—O—CH₂CH(OH)CH₂—O—, wherein two R groups are trimethylsiloxy and the third is C₁-C₈ alkyl (preferably C₁-C₃ alkyl, more preferably methyl) or C₃-C₈ cycloalkyl. In a still further example, G is a polymerizable group, such as (meth)acrylate. Such compounds may function as crosslinkers.

B-19. Compounds of formulae B, B-1, B-2, B-3, B-4, B-5, B-6, B-7, B-8, and B-9 may include compounds of formula B-19, which are compounds of formula B, B-1, B-2, B-3, B-4, B-5, B-6, B-7, B-8, or B-9 wherein Rg comprises styryl and the linking group is amine-oxaalkylene optionally substituted with hydroxyl. An example of such a linking group is —NH—CH₂CH(OH)CH₂—O—(CH₂)₃—.

B-20. Compounds of formulae B, B-1, B-2, B-3, B-4, B-5, B-6, B-7, B-8, and B-9 may include compounds of formula B-20, which are compounds of formula B, B-1, B-2, B-3, B-4, B-5, B-6, B-7, B-8, or B-9 wherein Rg comprises styryl and the linking group is alkyleneoxy-carbamate-oxaalkylene. An example of such a linking group is —O—(CH₂)₂—N(H)C(═O)O—(CH₂)₂—O—(CH₂)₃—.

B-21. Compounds of formulae B, B-1, B-2, B-3, B-4, B-5, B-6, B-7, B-8, and B-9 may include compounds of formula B-21, which are compounds of formula B, B-1, B-2, B-3, B-4, B-5, B-6, B-7, B-8, or B-9 wherein the linking group is alkylene-carbamate-oxaalkylene. An example of such a linking group is —(CH₂)₂—N(H)C(═O)O—(CH₂)₂—O—(CH₂)₃—.

Formula C. Silicone-containing components of formulae A, B, B-1, B-2, B-3, B-4, B-5, B-6, B-7, B-8, B-9, B-10, B-11, B-12, B-13, B-14, B-15, B-18, and B-21 may include compounds of formula C, which are compounds of formula A, B, B-1, B-2, B-3, B-4, B-5, B-6, B-7, B-8, B-9, B-10, B-11, B-12, B-13, B-14, B-15, B-18, or B-21 having the structure:

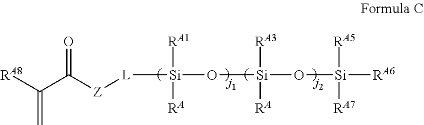

wherein

R^{A8} is hydrogen or methyl;

Z is O, S, or N(R^{A9}); and

L, j1, j2, R^{A1}, R^{A2}, R^{A3}, R^{A4}, R^{A5}, R^{A6}, R^{A7}, and R^{A9} are as defined in formula B or its various sub-formulae (e.g., B-1, B-2, etc.).

C-1. Compounds of formula C may include (meth)acrylates of formula C-1, which are compounds of formula C wherein Z is O.

C-2. Compounds of formula C may include (meth)acrylamides of formula C-2, which are compounds of formula C wherein Z is N(R^{A9}), and R^{A9} is H.

C-3. Compounds of formulae C may include (meth)acrylamides of formula C-3, which are compounds of formula C wherein Z is N(R^{A9}), and R^{A9} is C₁-C₈ alkyl that is unsubstituted or is optionally substituted as indicated above. Examples of R^{A9} include CH₃, —CH₂CH(OH)CH₂(OH), —(CH₂)₃-siloxanyl, —(CH₂)₃—SiR₃, and —CH₂CH(OH)CH₂—O—(CH₂)₃—SiR₃ where each R in the foregoing groups is independently selected from trimethylsiloxy, C₁-C₈ alkyl (preferably C₁-C₃ alkyl, more preferably methyl), and C₃-C₈ cycloalkyl. Further examples of R^{A9} include: —(CH₂)₃—Si(Me)(SiMe₃)₂, and —(CH₂)₃—Si(Me₂)—[O—SiMe₂]_{1,10}—CH₃.

Formula D. Compounds of formula C may include compounds of formula D:

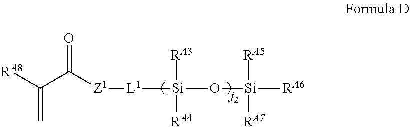

wherein

R^{A8} is hydrogen or methyl;

Z¹ is O or N(R^{A9});

L¹ is alkylene containing 1 to 8 carbon atoms, or oxaalkylene containing 3 to 10 carbon atoms, wherein L^{l} is optionally substituted with hydroxyl; and

j2, R^{A3}, R^{A4}, R^{A5}, R^{A6}, R^{A7}, and R^{A9} are as defined above in formula B or its various sub-formulae (e.g., B-1, B-2, etc.).

D-1. Compounds of formula D may include compounds of formula D-1, which are compounds of formula D wherein L¹ is C₂-C₅ alkylene optionally substituted with hydroxyl. Preferably L¹ is n-propylene optionally substituted with hydroxyl.

D-2. Compounds of formula D may include compounds of formula D-2, which are compounds of formula D wherein L¹ is oxaalkylene containing 4 to 8 carbon atoms optionally substituted with hydroxyl. Preferably L¹ is oxaalkylene containing five or six carbon atoms optionally substituted with hydroxyl. Examples include —(CH₂)₂—O—(CH₂)₃—, and —CH₂CH(OH)CH₂—O—(CH₂)₃—.

D-3. Compounds of formulae D, D-1, and D-2 may include compounds of formula D-3, which are compounds of formula D, D-1, or D-2 wherein Z¹ is O.

D-4. Compounds of formulae D, D-1, and D-2 may include compounds of formula D-4, which are compounds of formula D, D-1, or D-2 wherein Z¹ is N(R^{A9}), and R^{A9} is H.

D-5. Compounds of formulae D, D-1, and D-2 may include compounds of formula D-5, which are compounds of formula D, D-1, or D-2 wherein Z¹ is N(R^{A9}), and R^{A9} is C₁-C₄ alkyl optionally substituted with 1 or 2 substituents selected from hydroxyl, siloxy, and C₁-C₆ alkyl-siloxanyl-.

D-6. Compounds of formulae D, D-1, D-2, D-3, D-4, and D-5 may include compounds of formula D-6, which are compounds of formula D, D-1, D-2, D-3, D-4, or D-5 wherein j2 is 1.

D-7. Compounds of formulae D, D-1, D-2, D-3, D-4, and D-5 may include compounds of formula D-7, which are compounds of formula D, D-1, D-2, D-3, D-4, or D-5 wherein j2 is from 2 to 220, or from 2 to 100, or from 10 to 100, or from 24 to 100, or from 4 to 20, or from 4 to 10.

D-8. Compounds of formulae D, D-1, D-2, D-3, D-4, D-5, D-6, and D-7 may include compounds of formula D-8, which are compounds of formula D, D-1, D-2, D-3, D-4, D-5, D-6, or D-7 wherein R^{A3}, R^{A4}, R^{A5}, R^{A6}, and R^{A7} are independently C₁-C₆ alkyl or siloxy. Preferably R^{A3}, R^{A4}, R^{A5}, R^{A6}, and R^{A7} are independently selected from methyl, ethyl, n-propyl, n-butyl, and trimethylsiloxy. More preferably, R^{A3}, R^{A4}, R^{A5}, R^{A6}, and R^{A7} are independently selected from methyl, n-butyl, and trimethylsiloxy.

D-9. Compounds of formulae D, D-1, D-2, D-3, D-4, D-5, D-6, and D-7 may include compounds of formula D-9, which are compounds of formula D, D-1, D-2, D-3, D-4, D-5, D-6, or D-7 wherein R^{A3} and R^{A4} are independently C₁-C₆ alkyl (e.g., methyl or ethyl) or siloxy (e.g., trimethylsiloxy), and R^{A5}, R^{A6}, and R^{A7} are independently C₁-C₆ alkyl (e.g., methyl, ethyl, n-propyl, or n-butyl).

Formula E. The silicone-containing component may comprise a multi-functional silicone-containing component. Thus, for example, the silicone-containing component of formula A may comprise a bifunctional material of formula E:

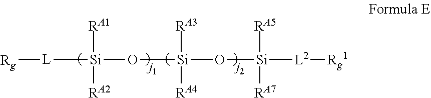

wherein

Rg, L, j1, j2, R^{A1}, R^{A2}, R^{A3}, R^{A4}, R^{A5}, and R^{A7} are as defined above for formula B or its various sub-formulae (e.g., B-1, B-2, etc.);

L² is a linking group; and

Rg¹ is a polymerizable group.

E-1. Compounds of formula E may include compounds of formula E-1, which are compounds of formula E wherein Rg and Rg¹ are each a vinyl carbonate of structure CH₂═CH—O—C(═O)—O— or structure CH₂=C(CH₃)—O—C(═O)—O—.

E-2. Compounds of formula E may include compounds of formula E-2, which are compounds of formula E wherein Rg and Rg¹ are each (meth)acrylate.

E-3. Compounds of formula E may include compounds of formula E-3, which are compounds of formula E wherein Rg and Rg¹ are each (meth)acrylamide, wherein the nitrogen group may be substituted with R^{A9} (wherein R^{A9} is as defined above).

E-4. Suitable compounds of formulae E, E-1, E-2, and E-3 include compounds of formula E-4, which are compounds of formula E, E-1, E-2, or E-3 wherein j1 is zero and j2 is from 1 to 220, or j2 is from 1 to 100, or j2 is from 1 to 50, or j2 is from 1 to 20.

E-5. Suitable compounds of formulae E, E-1, E-2, and E-3 include compounds of formula E-5, which are compounds of formula E, E-1, E-2, or E-3, wherein j1 and j2 are independently from 4 to 100.

E-6. Suitable compounds of formulae E, E-1, E-2, E-3, E-4, and E-5 include compounds of formula E-6, which are compounds of formula E, E-1, E-2, E-3, E-4, or E-5 wherein R^{A1}, R^{A2}, R^{A3}, R^{A4}, and R^{A5} are independently at each occurrence C₁-C₆ alkyl, preferably they are independently C₁-C₃ alkyl, or preferably, each is methyl.

E-7. Suitable compounds of formulae E, E-1, E-2, E-3, E-4, E-5, and E-6 include compounds of formula E-7, which are compounds of formula E, E-1, E-2, E-3, E-4, E-5, or E-6 wherein R^{A7} is alkoxy-alkyleneoxy-alkyl, preferably it is a methoxy capped polyethyleneoxyalkyl of formula CH₃O—[CH₂CH₂O]ₚ—CH₂CH₂CH₂, wherein p is a whole number from 1 to 50, or from 1 to 30, or from 1 to 10, or from 6 to 10.

E-8. Suitable compounds of formulae E, E-1, E-2, E-3, E-4, E-5, E-6, and E-7 include compounds of formula E-8, which are compounds of formula E, E-1, E-2, E-3, E-4, E-5, E-6, or E-7 wherein L comprises alkylene, carbamate, siloxanyl, cycloalkylene, amide, haloalkyleneoxy, oxaalkylene, or combinations of two or more thereof, wherein the linking group is optionally substituted with one or more substituents independently selected from alkyl, hydroxyl, ether, amine, carbonyl, and carbamate.

E-9. Suitable compounds of formulae E, E-1, E-2, E-3, E-4, E-5, E-6, E-7, and E-8 include compounds of formula E-9, which are compounds of formula E, E-1, E-2, E-3, E-4, E-5, E-6, E-7, or E-8 wherein L² comprises alkylene, carbamate, siloxanyl, cycloalkylene, amide, haloalkyleneoxy, oxaalkylene, or combinations of two or more thereof, wherein the linking group is optionally substituted with one or more substituents independently selected from alkyl, hydroxyl, ether, amine, carbonyl, and carbamate.

Examples of silicone-containing components suitable for use in the invention include, but are not limited to, compounds listed in the table below. Where the compounds in the table below include polysiloxane groups, the number of SiO repeat units in such compounds, unless otherwise indicated, is preferably from 3 to 100, more preferably from 3 to 40, or still more preferably from 3 to 20.

| | |
|---|---|
| 1 | mono-methacryloxypropyl terminated mono-n-butyl terminated polydimethylsiloxanes |
| | (mPDMS) (preferably containing from 3 to 15 SiO repeating units) |
| 2 | mono-acryloxypropyl terminated mono-n-butyl terminated polydimethylsiloxane |
| 3 | mono(meth)acryloxypropyl terminated mono-n-methyl terminated |
| | polydimethylsiloxane |
| 4 | mono(meth)acryloxypropyl terminated mono-n-butyl terminated polydiethylsiloxane |
| 5 | mono(meth)acryloxypropyl terminated mono-n-methyl terminated polydiethylsiloxane |
| 6 | mono(meth)acrylamidoalkylpolydialkylsiloxanes |
| 7 | mono(meth)acryloxyalkyl terminated mono-alkyl polydiarylsiloxanes |
| 8 | 3-methacryloxypropyltris(trimethylsiloxy)silane (TRIS) |
| 9 | 3-methacryloxypropylbis(trimethylsiloxy)methylsilane |
| 10 | 3-methacryloxypropylpentamethyl disiloxane |
| 11 | mono(meth)acrylamidoalkylpolydialkylsiloxanes |
| 12 | mono(meth)acrylamidoalkyl polydimethylsiloxanes |
| 13 | N-(2,3-dihydroxypropane)-N′-(propyl tetra(dimethylsiloxy) |
| | dimethylbutylsilane)acrylamide |
| 14 | N-[3-tris(trimethylsiloxy)silyl]-propyl acrylamide (TRIS-Am) |
| 15 | 2-hydroxy-3-[3-methyl-3,3-di(trimethylsiloxy)silylpropoxy]-propyl methacrylate |
| | (SiMAA) |
| 16 | 2-hydroxy-3-methacryloxypropyloxypropyl-tris(trimethylsiloxy)silane |
| 17 | mono-(2-hydroxy-3-methacryloxypropyl)-propyl ether terminated mono-n-butyl |
| | terminated polydimethylsiloxanes (OH-mPDMS) (containing from 4 to 30, or from 10 |
| | to 20, or from 4 to 8 SiO repeat units) |
| 18 | 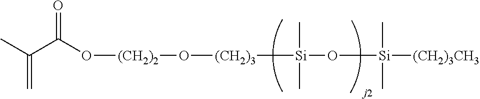 |
| 19 | 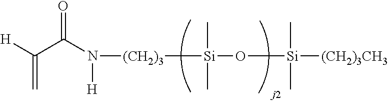 |
| 20 | 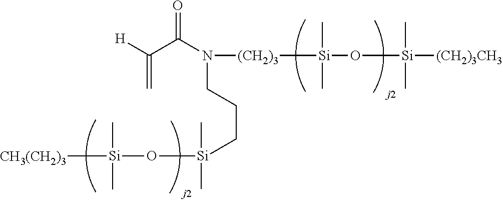 |
| 21 | 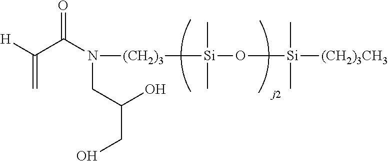 |
| 22 | 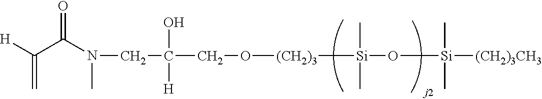 |
| 23 | 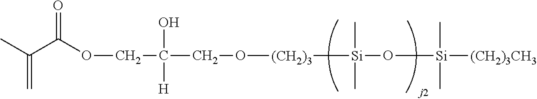 |
| 24 | 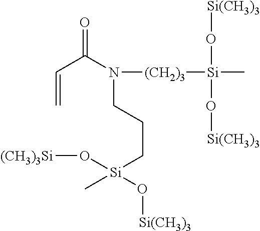 |

Additional non-limiting examples of suitable silicone-containing components are listed in the table below. Unless otherwise indicated, j2 where applicable is preferably from 1 to 100, more preferably from 3 to 40, or still more preferably from 3 to 15. In compounds containing j1 and j2, the sum of j1 and j2 is preferably from 2 to 100, more preferably from 3 to 40, or still more preferably from 3 to 15.

| | |
|---|---|
| 25 | 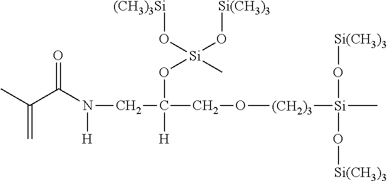 |
| 26 | 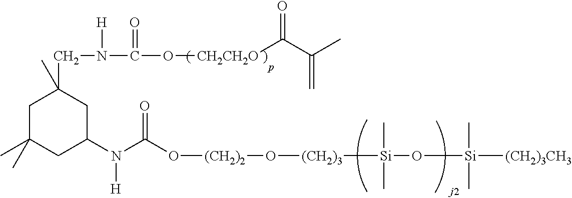 |
| | p is 1 to 10 |
| 27 | 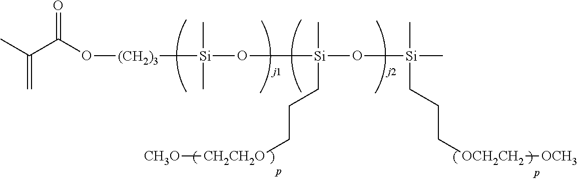 |
| | p is 5-10 |
| 28 | 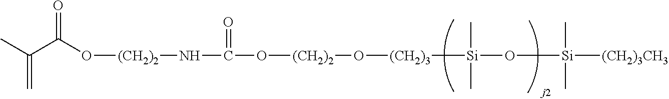 |
| 29 | 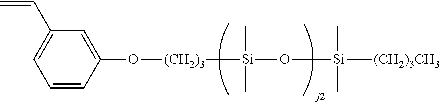 |
| 30 | 1,3-bis[4-(vinyloxycarbonyloxy)but-1-yl]tetramethyl-disiloxane |
| 31 | 3-(vinyloxycarbonylthio) propyl-(trimethylsiloxy)silane |
| 32 | 3-propyl allyl carbamate |
| 33 | 3-propyl vinyl carbamate |
| 34 | tris(trimethylsiloxy)silylstyrene (Styryl-TRIS) |
| 35 | 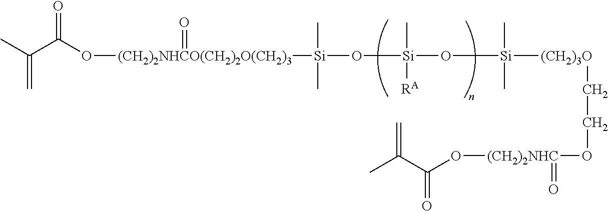 |
| | R^{A} = CH₃ (a) or CH₂CH₂CF₃ (b) or CH₂—(CH₂)₂— |
| | [OCH₂CH₂]₁₋₁₀—OCH₃ (c); a + b + c = n |
| 36 | 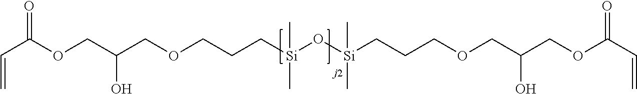 |
| 37 | 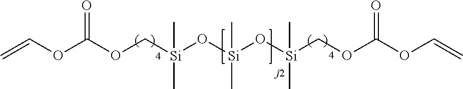 |
| 38 | 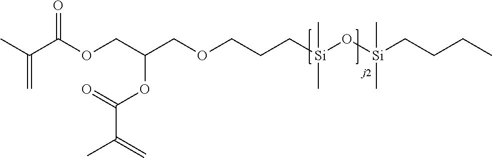 |
| 39 | 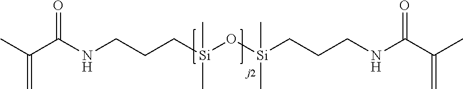 |
| 40 | 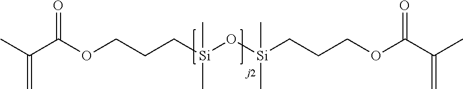 |
| 41 | 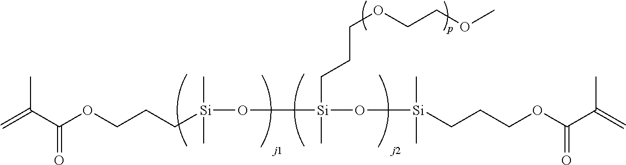 |
| | j1 = 80-90 |
| | j2 = 5-6 |
| | p = 7-8 |

Silicone-containing components may have an average molecular weight of from about 400 to about 4000 daltons.

The silicone containing component(s) may be present in amounts up to about 95 weight %, or from about 10 to about 80 weight %, or from about 20 to about 70 weight %, based upon all reactive components of the reactive mixture (excluding diluents).

### Polyamides

The reactive monomer mixture may include at least one polyamide. As used herein, the term “polyamide” refers to polymers and copolymers comprising repeating units containing amide groups. The polyamide may comprise cyclic amide groups, acyclic amide groups and combinations thereof and may be any polyamide known to those of skill in the art. Acyclic polyamides comprise pendant acyclic amide groups and are capable of association with hydroxyl groups. Cyclic polyamides comprise cyclic amide groups and are capable of association with hydroxyl groups.

Examples of suitable acyclic polyamides include polymers and copolymers comprising repeating units of Formulae G1 and G2:

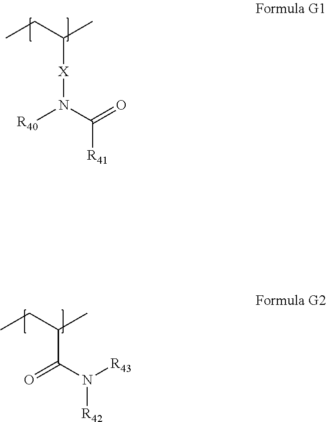

wherein X is a direct bond, —(CO)—, or —(CONHR₄₄)—, wherein R₄₄ is a C₁ to C₃ alkyl group; R₄₀ is selected from H, straight or branched, substituted or unsubstituted C₁ to C₄ alkyl groups; R₄₁ is selected from H, straight or branched, substituted or unsubstituted C₁ to C₄ alkyl groups, amino groups having up to two carbon atoms, amide groups having up to four carbon atoms, and alkoxy groups having up to two carbon groups; R₄₂ is selected from H, straight or branched, substituted or unsubstituted C₁ to C₄ alkyl groups; or methyl, ethoxy, hydroxyethyl, and hydroxymethyl; R₄₃ is selected from H, straight or branched, substituted or unsubstituted C₁ to C₄ alkyl groups; or methyl, ethoxy, hydroxyethyl, and hydroxymethyl; wherein the number of carbon atoms in R₄₀ and R₄₁ taken together is 8 or less, including 7, 6, 5, 4, 3, or less; and wherein the number of carbon atoms in R₄₂ and R₄₃ taken together is 8 or less, including 7, 6, 5, 4, 3, or less. The number of carbon atoms in R₄₀ and R₄₁ taken together may be 6 or less or 4 or less. The number of carbon atoms in R₄₂ and R₄₃ taken together may be 6 or less. As used herein substituted alkyl groups include alkyl groups substituted with an amine, amide, ether, hydroxyl, carbonyl or carboxy groups or combinations thereof.

R₄₀ and R₄₁ may be independently selected from H, substituted or unsubstituted C₁ to C₂ alkyl groups. X may be a direct bond, and R₄₀ and R₄₁ may be independently selected from H, substituted or unsubstituted C₁ to C₂ alkyl groups. R₄₂ and R₄₃ can be independently selected from H, substituted or unsubstituted C₁ to C₂ alkyl groups, methyl, ethoxy, hydroxyethyl, and hydroxymethyl.

The acyclic polyamides of the present invention may comprise a majority of the repeating units of Formula LV or Formula LVI, or the acyclic polyamides can comprise at least 50 mole percent of the repeating unit of Formula G or Formula G1, including at least 70 mole percent, and at least 80 mole percent. Specific examples of repeating units of Formula G and Formula G1 include repeating units derived from N-vinyl-N-methylacetamide, N-vinylacetamide, N-vinyl-N-methylpropionamide, N-vinyl-N-methyl-2-methylpropionamide, N-vinyl-2-methyl-propionamide, N-vinyl-N,N′-dimethylurea, N, N-dimethylacrylamide, methacrylamide, and acyclic amides of Formulae G2 and G3:

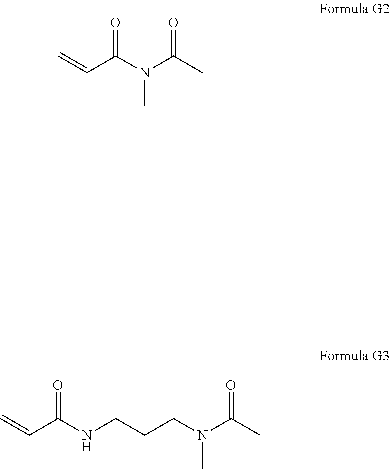

Examples of suitable cyclic amides that can be used to form the cyclic polyamides of include α-lactam, β-lactam, γ-lactam, δ-lactam, and ϵ-lactam. Examples of suitable cyclic polyamides include polymers and copolymers comprising repeating units of Formula G4:

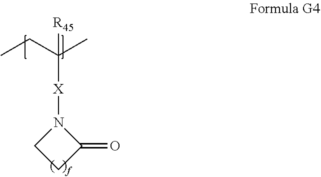

wherein R₄₅ is a hydrogen atom or methyl group; wherein f is a number from 1 to 10; wherein X is a direct bond, —(CO)—, or —(CONHR₄₆)—, wherein R₄₆ is a C₁ to C₃ alkyl group. In Formula LIX, f may be 8 or less, including 7, 6, 5, 4, 3, 2, or 1. In Formula G4, f may be 6 or less, including 5, 4, 3, 2, or 1. In Formula G4, f may be from 2 to 8, including 2, 3, 4, 5, 6, 7, or 8. In Formula LIX, f may be 2 or 3. When X is a direct bond, f may be 2. In such instances, the cyclic polyamide may be polyvinylpyrrolidone (PVP).

Cyclic polyamides may comprise 50 mole percent or more of the repeating unit of Formula G4, or the cyclic polyamides can comprise at least 50 mole percent of the repeating unit of Formula G4, including at least 70 mole percent, and at least 80 mole percent.

The polyamides may also be copolymers comprising repeating units of both cyclic and acyclic amides. Additional repeating units may be formed from monomers selected from hydroxyalkyl(meth)acrylates, alkyl(meth)acrylates, other hydrophilic monomers and siloxane substituted (meth)acrylates. Any of the monomers listed as suitable hydrophilic monomers may be used as comonomers to form the additional repeating units. Specific examples of additional monomers which may be used to form polyamides include 2-hydroxyethyl (meth)acrylate, vinyl acetate, acrylonitrile, hydroxypropyl (meth)acrylate, methyl (meth)acrylate and hydroxybutyl (meth)acrylate, dihydroxypropyl (meth)acrylate, polyethylene glycol mono(meth)acrylate, and the like and mixtures thereof. Ionic monomers may also be included. Examples of ionic monomers include (meth)acrylic acid, N-[(ethenyloxy)carbonyl]-β-alanine (VINAL, CAS #148969-96-4), 3-acrylamidopropanoic acid (ACA1), 5-acrylamidopentanoic acid (ACA2), 3-acrylamido-3-methylbutanoic acid (AMBA), 2-(methacryloyloxy)ethyl trimethylammonium chloride (Q Salt or METAC), 2-acrylamido-2-methylpropane sulfonic acid (AMPS), 1-propanaminium, N-(2-carboxyethyl)-N,N-dimethyl-3-[(1-oxo-2-propen-1-yl)amino]-, inner salt (CBT, carboxybetaine; CAS 79704-35-1), 1-propanaminium, N,N-dimethyl-N-[3-[(1-oxo-2-propen-1-yl)amino]propyl]-3-sulfo-, inner salt (SBT, sulfobetaine, CAS 80293-60-3), 3,5-Dioxa-8-aza-4-phosphaundec-10-en-1-aminium, 4-hydroxy-N,N,N-trimethyl-9-oxo-, inner salt, 4-oxide (9CI) (PBT, phosphobetaine, CAS 163674-35-9, 2-methacryloyloxyethyl phosphorylcholine, 3-(dimethyl(4-vinylbenzyl)ammonio)propane-1-sulfonate (DMVBAPS), 3-((3-acrylamidopropyl)dimethylammonio)propane-1-sulfonate (AMPDAPS), 3-((3-methacrylamidopropyl)dimethylammonio)propane-1-sulfonate (MAMPDAPS), 3-((3-(acryloyloxy)propyl)dimethylammonio)propane-1-sulfonate (APDAPS), 3-((3-(methacryloyloxy)propyl)dimethylammonio)propane-1-sulfonate (MAPDAPS).

The reactive monomer mixture may comprise both an acyclic polyamide and a cyclic polyamide or copolymers thereof. The acyclic polyamide can be any of those acyclic polyamides described herein or copolymers thereof, and the cyclic polyamide can be any of those cyclic polyamides described herein or copolymers thereof. The polyamide may be selected from the group polyvinylpyrrolidone (PVP), polyvinylmethylacetamide (PVMA), polydimethylacrylamide (PDMA), polyvinylacetamide (PNVA), poly hydroxyethyl (meth)acrylamide, polyacrylamide, and copolymers and mixtures thereof.

The total amount of all polyamides in the reactive mixture may be in the range of between 1 weight percent and about 35 weight percent, including in the range of about 1 weight percent to about 15 weight percent, and in the range of about 5 weight percent to about 15 weight percent, in all cases, based on the total weight of the reactive components of the reactive monomer mixture.

Without intending to be bound by theory, when used with a silicone hydrogel, the polyamide functions as an internal wetting agent. The polyamides may be non-polymerizable, and in this case, are incorporated into the silicone hydrogels as semi-interpenetrating networks. The polyamides are entrapped or physically retained within the silicone hydrogels. Alternatively, the polyamides may be polymerizable, for example as polyamide macromers or prepolymers, and in this case, are covalently incorporated into the silicone hydrogels. Mixtures of polymerizable and non-polymerizable polyamides may also be used.

When the polyamides are incorporated into the reactive monomer mixture they may have a weight average molecular weight of at least 100,000 daltons; greater than about 150,000; between about 150,000 to about 2,000,000 daltons; between about 300,000 to about 1,800,000 daltons. Higher molecular weight polyamides may be used if they are compatible with the reactive monomer mixture.

### Cross-Linking Agents

It is generally desirable to add one or more cross-linking agents, also referred to as cross-linking monomers, multi-functional macromers, and prepolymers, to the reactive mixture. The cross-linking agents may be selected from bifunctional crosslinkers, trifunctional crosslinkers, tetrafunctional crosslinkers, and mixtures thereof, including silicone-containing and non-silicone containing cross-linking agents. Non-silicone-containing cross-linking agents include ethylene glycol dimethacrylate (EGDMA), tetraethylene glycol dimethacrylate (TEGDMA), trimethylolpropane trimethacrylate (TMPTMA), triallyl cyanurate (TAC), glycerol trimethacrylate, methacryloxyethyl vinylcarbonate (HEMAVc), allyl methacrylate, methylene bisacrylamide (MBA), and polyethylene glycol dimethacrylate wherein the polyethylene glycol has a molecular weight up to about 5000 Daltons. The cross-linking agents are used in the usual amounts, e.g., from about 0.000415 to about 0.0156 mole per 100 grams of reactive Formulas in the reactive mixture. Alternatively, if the hydrophilic monomers and/or the silicone-containing components are multifunctional by molecular design or because of impurities, the addition of a cross-linking agent to the reactive mixture is optional. Examples of hydrophilic monomers and macromers which can act as the cross-linking agents and when present do not require the addition of an additional cross-linking agent to the reactive mixture include (meth)acrylate and (meth)acrylamide endcapped polyethers. Other cross-linking agents will be known to one skilled in the art and may be used to make the silicone hydrogel of the present invention.

It may be desirable to select crosslinking agents with similar reactivity to one or more of the other reactive components in the formulation. In some cases, it may be desirable to select a mixture of crosslinking agents with different reactivity in order to control some physical, mechanical or biological property of the resulting silicone hydrogel. The structure and morphology of the silicone hydrogel may also be influenced by the diluent(s) and cure conditions used.

Multifunctional silicone-containing components, including macromers, cross-linking agents, and prepolymers, may also be included to further increase the modulus and retain tensile strength. The silicone containing cross-linking agents may be used alone or in combination with other cross-linking agents. An example of a silicone containing component which can act as a cross-linking agent and, when present, does not require the addition of a crosslinking monomer to the reactive mixture includes a, w-bismethacryloxypropyl polydimethylsiloxane.

Cross-linking agents that have rigid chemical structures and polymerizable groups that undergo free radical polymerization may also be used. Non-limiting examples of suitable rigid structures include cross-linking agents comprising phenyl and benzyl moieties, such are 1,4-phenylene diacrylate, 1,4-phenylene dimethacrylate, 2,2-bis(4-methacryloxyphenyl)-propane, 2,2-bis[4-(2-acryloxyethoxy)phenyl]propane, 2,2-bis[4-(2-hydroxy-3-methacryloxypropoxy)-phenyl]propane, and 4-vinylbenzyl methacrylate, and combinations thereof Rigid crosslinking agents may be included in amounts between about 0.5 and about 15, or 2-10, 3-7 based upon the total weight of all of the reactive components. The physical and mechanical properties of the silicone hydrogels of the present invention may be optimized for a particular use by adjusting the components in the reactive mixture.

Non-limiting examples of silicone cross-linking agents also include the multi-functional silicone-containing components described above, such as compounds of Formula E (and its sub-formulae) and the multi-functional compounds shown in the tables above.

### Further Constituents

If desired, the reactive monomer mixture may contain additional components such as, but not limited to, diluents, initiators, UV absorbers, visible light absorbers, photochromic compounds, pharmaceuticals, nutraceuticals, antimicrobial substances, tints, pigments, copolymerizable dyes, nonpolymerizable dyes, release agents, and combinations thereof.

Classes of suitable diluents for silicone hydrogel reactive mixtures include alcohols having 2 to 20 carbon atoms, amides having 10 to 20 carbon atoms derived from primary amines and carboxylic acids having 8 to 20 carbon atoms. The diluents may be primary, secondary, and tertiary alcohols.

Generally, the reactive components are mixed in a diluent to form a reactive mixture. Suitable diluents are known in the art. For silicone hydrogels, suitable diluents are disclosed in WO 03/022321 and U.S. Pat. No. 6,020,445 the disclosure of which is incorporated herein by reference. Classes of suitable diluents for silicone hydrogel reactive mixtures include alcohols having 2 to 20 carbons, amides having 10 to 20 carbon atoms derived from primary amines, and carboxylic acids having 8 to 20 carbon atoms. Primary and tertiary alcohols may be used. Preferred classes include alcohols having 5 to 20 carbons and carboxylic acids having 10 to 20 carbon atoms. Specific diluents which may be used include 1-ethoxy-2-propanol, diisopropyl aminoethanol, isopropanol, 3,7-dimethyl-3-octanol, 1-decanol, 1-dodecanol, 1-octanol, 1-pentanol, 2-pentanol, 1-hexanol, 2-hexanol, 2-octanol, 3-methyl-3-pentanol, tert-amyl alcohol, tert-butanol, 2-butanol, 1-butanol, 2-methyl-2-pentanol, 2-propanol, 1-propanol, ethanol, 2-ethyl-1-butanol, (3-acetoxy-2-hydroxypropyloxy)-propylbis(trimethylsiloxy) methylsilane, 1-tert-butoxy-2-propanol, 3,3-dimethyl-2-butanol, tert-butoxyethanol, 2-octyl-1-dodecanol, decanoic acid, octanoic acid, dodecanoic acid, 2-(diisopropylamino)ethanol mixtures thereof and the like. Examples of amide diluents include N,N-dimethyl propionamide and dimethyl acetamide.

Preferred diluents include 3,7-dimethyl-3-octanol, 1-dodecanol, 1-decanol, 1-octanol, 1-pentanol, 1-hexanol, 2-hexanol, 2-octanol, 3-methyl-3-pentanol, 2-pentanol, t-amyl alcohol, tert-butanol, 2-butanol, 1-butanol, 2-methyl-2-pentanol, 2-ethyl-1-butanol, ethanol, 3,3-dimethyl-2-butanol, 2-octyl-1-dodecanol, decanoic acid, octanoic acid, dodecanoic acid, mixtures thereof and the like.

More preferred diluents include 3,7-dimethyl-3-octanol, 1-dodecanol, 1-decanol, 1-octanol, 1-pentanol, 1-hexanol, 2-hexanol, 2-octanol, 1-dodecanol, 3-methyl-3-pentanol, 1-pentanol, 2-pentanol, t-amyl alcohol, tert-butanol, 2-butanol, 1-butanol, 2-methyl-2-pentanol, 2-ethyl-1-butanol, 3,3-dimethyl-2-butanol, 2-octyl-1-dodecanol, mixtures thereof and the like. If a diluent is present, generally there are no particular restrictions with respect to the amount of diluent present. When diluent is used, the diluent may be present in an amount in the range of about 2 to about 70 weight percent, including in the range of about 5 to about 50 weight percent, and in the range of about 15 to about 40 weight percent, based on the total weight of the reactive mixtures (including reactive and nonreactive Formulas). Mixtures of diluents may be used.

A polymerization initiator may be used in the reactive mixture. The polymerization initiator may include, for instance, at least one of lauroyl peroxide, benzoyl peroxide, iso-propyl percarbonate, azobisisobutyronitrile, and the like, that generate free radicals at moderately elevated temperatures, and photoinitiator systems such as aromatic alpha-hydroxy ketones, alkoxyoxybenzoins, acetophenones, acylphosphine oxides, bisacylphosphine oxides, and a tertiary amine plus an a-diketone, mixtures thereof and the like. Illustrative examples of photoinitiators are 1-hydroxycyclohexyl phenyl ketone, 2-hydroxy-2-methyl-1-phenyl-propan-1-one, bis(2,6-dimethoxybenzoyl)-2,4-4-trimethylpentyl phosphine oxide (DMBAPO), bis(2,4,6-trimethylbenzoyl)-phenyl phosphine eoxide (Irgacure 819), 2,4,6-trimethylbenzyldiphenyl phosphine oxide and 2,4,6-trimethylbenzoyl diphenylphosphine oxide, benzoin methyl ester and a combination of camphorquinone and ethyl 4-(N,N-dimethylamino)benzoate. Diazo thermal initiators may also be used, such as azobisisobutyronitrile (AIBN), 2,2′-azobis(2-methylbutyronitrile) (AMBN) or similar compounds.

Commercially available visible light initiator systems include Irgacure® 819, Irgacure® 1700, Irgacure® 1800, Irgacure® 819, Irgacure® 1850 (all from Ciba Specialty Chemicals) and Lucrin® TPO initiator (available from BASF). Commercially available UV photoinitiators include Darocur® 1173 and Darocur® 2959 (Ciba Specialty Chemicals). These and other photoinitiators which may be used are disclosed in Volume III, Photoinitiators for Free Radical Cationic & Anionic Photopolymerization, 2nd Edition by J. V. Crivello & K. Dietliker; edited by G. Bradley; John Wiley and Sons; New York; 1998. The initiator is used in the reactive mixture in effective amounts to initiate photopolymerization of the reactive mixture, e.g., from about 0.1 to about 2 parts by weight per 100 parts of reactive monomer mixture. Polymerization of the reactive mixture can be initiated using the appropriate choice of heat or visible or ultraviolet light or other means depending on the polymerization initiator used. Alternatively, initiation can be conducted using e-beam without a photoinitiator. However, when a photoinitiator is used, the preferred initiators are bisacylphosphine oxides, such as bis(2,4,6-tri-methylbenzoyl)-phenyl phosphine oxide (Irgacure® 819) or a combination of 1-hydroxycyclohexyl phenyl ketone and bis(2,6-dimethoxybenzoyl)-2,4-4-trimethylpentyl phosphine oxide (DMBAPO).

The reactive mixture for making the ophthalmic devices of the invention may comprise, in addition to a population of core-shell particles described herein, any of the polymerizable compounds and optional components described above.

Preferred reactive mixtures may comprise: a hydroxyphenyl phenanthroline of formula I and a hydrophilic monomer.

Preferred reactive mixtures may comprise: a population of core-shell particles described herein; and a hydrophilic monomer selected from DMA, NVP, HEMA, VMA, NVA, methacrylic acid, and mixtures thereof. Preferred are mixtures of HEMA and methacrylic acid.

Preferred reactive mixtures may comprise: a population of core-shell particles described herein, a hydrophilic monomer, and a silicone-containing component.

Preferred reactive mixtures may comprise: a population of core-shell particles described herein, a hydrophilic monomer, and a silicone-containing component comprising a compound of formula D (or its sub-formulae, such as D-1, D-2, etc.).

Preferred reactive mixtures may comprise: a population of core-shell particles described herein, a hydrophilic monomer selected from DMA, NVP, HEMA, VMA, NVA, and mixtures thereof; a silicone-containing component comprising a compound of formula D (or its sub-formulae, such as D-1, D-2, etc.); and an internal wetting agent.

Preferred reactive mixtures may comprise: a population of core-shell particles described herein, a hydrophilic monomer selected from DMA, HEMA and mixtures thereof; a silicone-containing component selected from 2-hydroxy-3-[3-methyl-3,3-di(trimethylsiloxy)silylpropoxy]-propyl methacrylate (SiMAA), mono-methacryloxypropyl terminated mono-n-butyl terminated polydimethylsiloxane (mPDMS), mono-(2-hydroxy-3-methacryloxypropyl)-propyl ether terminated mono-n-butyl terminated polydimethylsiloxane (OH-mPDMS), and mixtures thereof; and a wetting agent (preferably PVP or PVMA). For the hydrophilic monomer, mixtures of DMA and HEMA are preferred. For the silicone containing component, mixtures of SiMAA and mPDMS are preferred.

The foregoing reactive mixtures may contain optional ingredients such as, but not limited to, one or more initiators, internal wetting agents, crosslinkers, other UV blockers, and diluents.

### Curing of Hydrogels and Manufacture of Lenses

The reactive mixtures may be formed by any of the methods known in the art, such as shaking or stirring, and used to form polymeric articles or devices by known methods. The reactive components are mixed together either with or without a diluent to form the reactive mixture.

For example, hydrogels may be prepared by mixing reactive components, and, optionally, diluent(s), with a polymerization initiator and curing by appropriate conditions to form a product that can be subsequently formed into the appropriate shape by lathing, cutting, and the like. Alternatively, the reactive mixture may be placed in a mold and subsequently cured into the appropriate article.

A method of making a silicone hydrogel contact lens may comprise: preparing a reactive monomer mixture; transferring the reactive monomer mixture onto a first mold; placing a second mold on top the first mold filled with the reactive monomer mixture; and curing the reactive monomer mixture by free radical copolymerization to form the silicone hydrogel in the shape of a contact lens.

The reactive mixture may be cured via any known process for molding the reactive mixture in the production of contact lenses, including spincasting and static casting. Spincasting methods are disclosed in U.S. Pat. Nos. 3,408,429 and 3,660,545, and static casting methods are disclosed in U.S. Pat. Nos. 4,113,224 and 4,197,266. The contact lenses of this invention may be formed by the direct molding of the silicone hydrogels, which is economical, and enables precise control over the final shape of the hydrated lens. For this method, the reactive mixture is placed in a mold having the shape of the final desired silicone hydrogel and the reactive mixture is subjected to conditions whereby the monomers polymerize, thereby producing a polymer in the approximate shape of the final desired product.

After curing, the lens may be subjected to extraction to remove unreacted components and release the lens from the lens mold. The extraction may be done using conventional extraction fluids, such organic solvents, such as alcohols or may be extracted using aqueous solutions.

Aqueous solutions are solutions which comprise water. The aqueous solutions of the present invention may comprise at least about 20 weight percent water, or at least about 50 weight percent water, or at least about 70 weight percent water, or at least about 95 weight percent water. Aqueous solutions may also include additional water soluble components such as inorganic salts or release agents, wetting agents, slip agents, pharmaceutical and nutraceutical compounds, combinations thereof and the like. Release agents are compounds or mixtures of compounds which, when combined with water, decrease the time required to release a contact lens from a mold, as compared to the time required to release such a lens using an aqueous solution that does not comprise the release agent. The aqueous solutions may not require special handling, such as purification, recycling or special disposal procedures.

Extraction may be accomplished, for example, via immersion of the lens in an aqueous solution or exposing the lens to a flow of an aqueous solution. Extraction may also include, for example, one or more of: heating the aqueous solution; stirring the aqueous solution; increasing the level of release aid in the aqueous solution to a level sufficient to cause release of the lens; mechanical or ultrasonic agitation of the lens; and incorporating at least one leaching or extraction aid in the aqueous solution to a level sufficient to facilitate adequate removal of unreacted components from the lens. The foregoing may be conducted in batch or continuous processes, with or without the addition of heat, agitation or both.

Application of physical agitation may be desired to facilitate leach and release. For example, the lens mold part to which a lens is adhered can be vibrated or caused to move back and forth within an aqueous solution. Other methods may include ultrasonic waves through the aqueous solution.

The lenses may be sterilized by known means such as, but not limited to, autoclaving.

Silicone hydrogel ophthalmic devices (e.g., contact lenses) described herein preferably have one or more of (and in some cases all of) the following properties. All values are prefaced by “about,” and the devices may have any combination of the listed properties. The properties may be determined by methods known to those skilled in the art, for instance as described in United States pre-grant publication US20180037690, which is incorporated herein by reference.

[H₂O] %: at least 20%, or at least 25%

Haze: 30% or less, or 10% or less

Kruss DCA (°): 100° or less, or 50° or less

Tensile Modulus (psi): 120 or less, or 80 to 120

Dk (barrers): at least 80, or at least 100, or at least 150, or at least 200

Elongation to Break: at least 100

For ionic silicon hydrogels, the following properties may also be preferred (in addition to those recited above):

Lysozyme uptake (μg/lens): at least 100, or at least 150, or at least 500, or at least 700

Polyquaternium 1 (PQ1) uptake (%): 15 or less, or 10 or less, or 5 or less

Examples of suitable materials for the fabrication of optical lenses, including eyeglass lenses, include CR-39 (allyl diglycol carbonate (ADC)), TRIVEX (commercially available from PPG Industries), SPECTRALITE (commercially available from SOLA), ORMEX (commercially available from Essilor), polycarbonate, acrylic, MR-8 Plastic (commercially available from Mitsui Chemicals), MR-6 Plastic (commercially available from Mitsui Chemicals), MR-20 Plastic (commercially available from Mitsui Chemicals), MR-7 Plastic (commercially available from Mitsui Chemicals), MR-10 Plastic (commercially available from Mitsui Chemicals), MR-174 Plastic (commercially available from Mitsui Chemicals), FINALITE (commercially available from SOLA), NL4 (commercially available from Nikon), 1.70 EYRY (commercially available from Hoya), HYPERINDEX 174 (commercially available from Optima), NL5 (commercially available from Nikon), plastics commercially available from Tokai Optical Co., Ltd., and glasses (e.g., crown glass, flint glass, PHOTOGRAY EXTRA glass commercially available from Corning, and high index glasses such as those commercially available from Zeiss).

Screen covers can include an optically transparent sheet or film configured to cover an LED display (e.g., a transparent sheet configured to cover a computer monitor, tablet screen, or cell phone screen). If desired, the screen cover can be integrated into a housing for an electronic device having an LED display. Such housings can comprise a shell configured to surround at least a portion of the electronic device, an aperture in the shell that is aligned with the LED display when the electronic device is disposed within the shell, and a membrane comprising a an optically transparent material described herein disposed within the aperture of the shell, such that when the electronic device is disposed within the shell, the membrane is positioned over the LED display of electronic device.

The optically transparent materials can also be fabricated into housings for LED lighting. The housings can filter one or more wavelengths of blue light emitted by an LED disposed within the housing.

The examples below are intended to further illustrate certain aspects of the materials and methods described herein, and is not intended to limit the scope of the claims

### EXAMPLES

### Materials and General Methods

Ethylene glycol (EG, 99.8%), silver trifluoroacetate (CF3COOAg, ≥99.99%), poly(vinylpyrrolidone) (PVP, ˜55,000 kDa), sodium chloride (NaCl), sodium hydrosulfide hydrate (NaHS⋅xH2O), tetraethyl orthosilicate (TEOS, 99.999% trace metals basis), ammonia (28-30% NH3 basis), acetone (≥99.9%), hydrochloric acid (HCl, ˜37%), nitric acid (HNO3, ˜70%) and anhydrous ethanol (EtOH, <0.003% H2O) were purchased from Sigma-Aldrich. All chemicals were used as received. 20 mL and 7 ml glass scintillation vials were purchased from VWR. Carbon Type-B, 400 mesh, Cu TEM grids were purchased from Ted Pella, Inc. All aqueous solutions used Millipore water (>15 MΩ·cm) produced by an EMD Millipore filtration instrument.

All glassware was cleaned prior to use with NaOH (12 M, 1 h) followed by washing with copious amounts of DI water and 3 washes of Millipore water. Stir bars were cleaned with aqua regia (3:1 HCl/HNO₃, 10 min) followed by washing with copious amount of Millipore-grade water.

40 nm (cat no. 795968) and 60 nm (cat no. 795984) spherical, PVP functionalized AgNPs were purchased from Sigma-Aldrich for comparison purposes. Optical properties of commercial AgNPs were measured in-house. Sizing information of commercial AgNPs are based off of the supplier's information.

Contact lens molds, etafilcon monomer mixture and blue light emitting lamps (NARVA LT 40 W-K, peak emission ˜420-430 nm) were received from Johnson and Johnson Vision Care. Contact lenses were stored in 20 mL scintillation vials filled with 7 mL of Millipore water.

### Synthesis of Plasmonic Silver Nanoparticle Cores

Synthesis of cubic silver NPs. The synthesis of cubic AgNPs was based on a modified polyol synthesis. 5 mL of EG was added to a 20 mL scintillation vial and heated in an oil bath set at a temperature between 115 and 130° C. The temperature was monitored throughout the entirety of the synthesis. All reagents were dissolved in EG and sequentially added to the scintillation vial placed in the oil bath. 90 μl of NaSH (3 mM) was first introduced, followed by PVP (20 g/L) and NaCl (1.5 mM) after a 2-minute delay. Lastly, 0.4 mL of CF3COOAg (282 mM) was introduced after 2 minutes. The scintillation vial was loosely capped, and aliquots were taken at 15-min intervals with a glass Pasteur pipette. All aliquots were diluted with Millipore water prior to analysis.

Synthesis of octahedra silver NPs. The synthesis parameters of octahedra AgNPs were identical to that of cubic AgNPs except for the concentration of NaCl. 0.5 mL of 0.075 mM NaCl was added to the scintillation vial to prepare octahedra AgNPs.

Coating of Plasmonic Nanoparticle Cores with Dielectric Shells

Synthesis of silver NPs. Cubic AgNPs were prepared using the optimized polyol synthesis conditions described above (e.g., temperature set at 115° C., 120-min reaction duration). Octahedra AgNPs were also prepared at 115° C., however the reaction duration was shortened to 105 minutes. A second octahedral AgNP sample (that was not silica coated) was prepared with slight variations in the synthesis to yield a red-shifted localized surface plasmon resonance (LSPR) peak. The reaction time was increased to 120 min and 7 ml of EG were added to the scintillation vial, instead of 5 ml.

The synthesis was quenched by immersing the sample vial in an ice bath. The final NP suspension was split into 3 mL portions, to which 50 mg of PVP were introduced. The NPs were precipitated with acetone and re-suspended in 3 mL EtOH, following centrifugation at 10,000 RPM for 13 min.

Coating of silver NPs. The AgNPs were coated with silica following a modified Stober-like growth process. A 10% TEOS solution (vol/vol %) was prepared in EtOH. 250 μl of ammonia and 100 μl of TEOS (10%) were introduced to the NP suspension in EtOH under magnetic stirring. The coating process continued over 12 h, during which time the scintillation vial was capped, and aliquots were taken every few hours with a micropipette. Following the 12-h silica coating, the NPs were washed with EtOH twice and collected via centrifugation at 10,000 RPM for 13 min. Following 2 rounds of centrifugation, the NPs were resuspended in EtOH and stored in the fridge (˜2° C.) until further use. All aliquots were diluted with Millipore water prior to TEM and UV-Vis analysis.

### Contact Lens Preparation and Testing

NP-integrated contact lenses. Silica-coated AgNPs (suspended in EtOH) or shell-free AgNPs were introduced into etafilcon monomer mixture at low volume concentrations (<1:14 ratio, vol/vol %). NPs were dispersed throughout the monomer mixture through vortexing. Six drops of the NP-monomer mixture were added to the back molds using a Pasteur pipette. The front molds were placed on top of the back molds (containing the monomer mixture). Molds were placed underneath the blue light emitting lamps for 20 min to photocure the monomer mixtures. After photocuring, the front molds were pried off the back molds and the back molds (containing the etafilcon lens) were placed in a hot DI water bath (70° C.) to separate the NP-integrated contact lenses from the molds.

UV exposure. The stability of the synthesized NP-integrated etafilcon lenses was tested under an array of UVA fluorescent bulbs (Philips F20T12/BL., Amsterdam, Netherlands, peak emission ˜350 nm) in an enclosed environment. The lenses were contained in transparent Gladwrap-sealed 20 mL scintillation vials filled with 7 mL of Millipore water. The UV intensity was measured to be ˜33.96 W/m² with a UVA/B light meter (Sper Scientific, Scottsdale, Ariz., USA, NIST certified calibration) which is slightly lower than the UV content of the solar spectrum (ASTM G173-03 global tilt). Cumulative UV exposure was adjusted such that lenses would receive the equivalent of 1, 3.5 or 7 days of solar UV exposure with the assumption that UV contributes to 4.72% of cumulative insolation.

Solar exposure. The stability of the prepared NP-integrated lenses was tested under natural sunlight exposure in Waterloo, Ontario. The lenses were placed in clear 20 mL vials filled with MDI and left outdoors during peak sunlight hours (10:00 AM to 4:15 PM). Weather data was obtained from the University of Waterloo Weather Station to assess the incident solar ration contacting the lenses during testing. The lenses were exposed to incident radiation ranging from 238.3 W/m² to 832.8 W/m² during the course of the study.

Autoclaving. NP-integrated etafilcon lenses were autoclaved for 20 minutes at 121° C. and 1.1 bar. Lenses were placed in loosely sealed 8 mL autoclavable glass, filled with 6 mL of MDI.

### Characterization

TEM. TEM samples were prepared by drop-casting a solution of the respective sample (2-10 μl ) on a TEM grid and allowed to dry under hood evaporation. The size and shape of the particles were analyzed with a Philips CM-10 transmission electron microscope (TEM).

Optical Measurements. Optical density (OD) spectra were obtained with a UV-Vis spectrophotometer (BioTek Epoch) in a 96-well plate or Take3 plate (BioTek).

ICP Sample Preparation of NP-Integrated Contact Lenses. 5 mL of the storage solution was diluted with 0.2 ml of concentrated HNO3 (-70%) and left undisturbed over 1 day to acid-digest NPs that may be present in solution. After the initial acid digestion, 4.8 ml of dilute nitric acid (0.7%) was introduced and the solution was left undisturbed for at least 24 h.

ICP Sample Preparation of Silica-coated AgNP. Silica-coated AgNPs were acid digested in a similar manner to the storage solution used to hydrate the contact lenses.

ICP Analysis. ICP-OES analysis for Ag+ ions were carried out using the model ProdigyPlus (Teledyne Leeman Labs). The detection range of this instrument was 15 ppb to 80 ppm and the lower limit of detection (LLOD) was found to be 15 ppb for Ag+ detection in Millipore water. Calibration standards containing 0, 9.6, 16, 32 and 80 ppm Ag as well as an internal standard of 10 ppm yttrium were used. Data was collected using Salsa software

### Results and Discussion

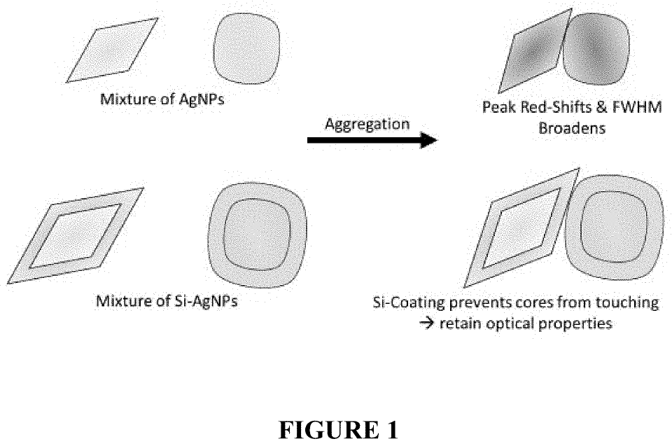

FIG. 1 is a schematic illustration showing the cross-section of example core-shell particles as well as the relationship between the core-shell structure and the photophysical properties of the core-shell particles. As illustrated in FIG. 1, the core-shell particles can include a plasmonic nanoparticle core comprising a noble metal (e.g., silver); and a shell comprising a dielectric material (e.g., silicon dioxide) surrounding the plasmonic nanoparticle core. By varying the size and shape of the plasmonic nanoparticle core, the optical properties of the plasmonic nanoparticle core (which arise through localized surface plasmon resonance) can be tuned. For example, the absorption of the plasmonic nanoparticle core can be tuned within the blue region of the electromagnetic spectrum (e.g., between 400 nm and 500 nm). The dielectric shell enveloping the plasmonic nanoparticle core can reduce the interaction between adjacent plasmonic nanoparticle cores, preventing broadening and/or redshifting of absorbance and/or scattering peak of the plasmonic nanoparticle cores. As a result, the core-shell particles can exhibit absorbance and/or scattering peaks in blue region of the electromagnetic spectrum which are both tunable and relatively narrow.

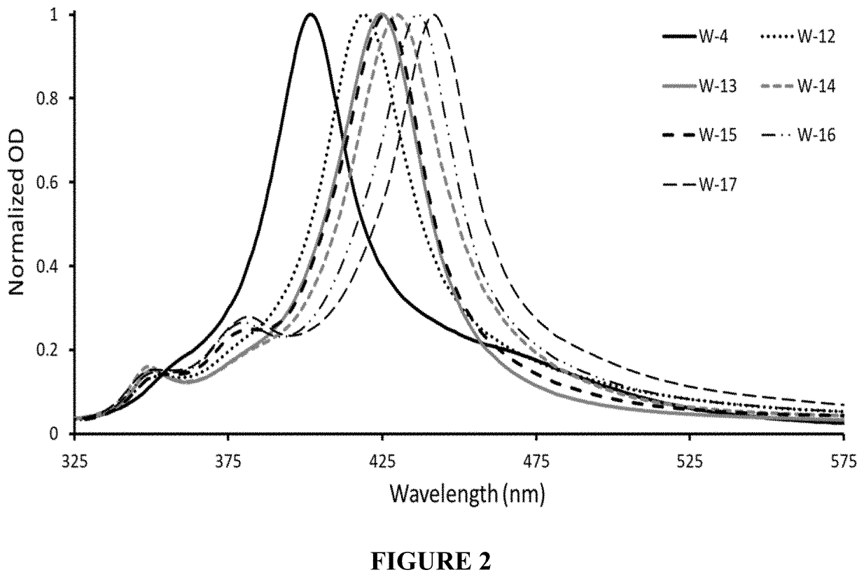

The morphology of seven example core-shell particles, as well as their photophysical properties, are summarized in the table below. FIG. 2 is a plot illustrating the normalized absorption of seven different example core-shell particles. As demonstrated by the spectra in FIG. 2, the absorption of the chore-shell particles can be tuned within the blue region of the electromagnetic spectrum (e.g., between 400 nm and 500 nm) by varying the size and shape of the plasmonic nanoparticle core.

| | Peak | OD Spectra | |
|---|---|---|---|
| Example | (nm) | FWHM (nm) | Shape |
| W-4 | 402 | 33 | Cubic (rounded) |
| W-12 | 419 | 36 | Cubic |
| W-13 | 425 | 36 | Cubic |
| W-14 | 430 | 40 | Cubic |
| W-15 | 426 | 36 | Mixture (cubes and octahedra) |
| W-16 | 436 | 36 | Mixture (cubes and octahedra) |
| W-17 | 442 | 36 | Mixture (cubes and octahedra) |

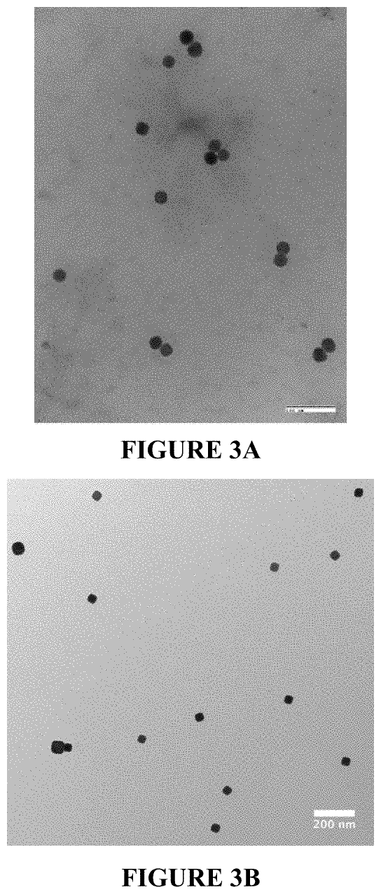

FIGS. 3A-3C are TEM micrographs showing three example plasmonic nanoparticle cores: Example W-4 (FIG. 3A; cubic silver particles having an average particle size of 25.4±1.2 nm); Example W-1 (FIG. 3B; cubic silver particles having an average particle size of 43.3±7.2 nm); and Example W-2 (FIG. 3C; a mixture of 44% cubic silver particles having an average particle size of 41.7±0.5 nm, 37% octahedral silver particles having an average particle size of 45.2±0.6 nm, and a small quantity (19%) of silver particles having decahedral, cubocahedral, and truncated bitetrahedral shapes). The photophysical properties and morphology of these particles are summarized in the table below.

| | | | Average | |
|---|---|---|---|---|
| | Peak | OD Spectra | Particle | |
| Example | (nm) | FWHM (nm) | Size (nm) | Shape |
| W-1 | 416 | 47 | 43.3 ± 7.2 | Cubic |
| W-2 | 423 | 40 | 41.7 ± 0.5 | 44% Cubic |
| | | | 45.2 ± 0.6 | 37% Octahedral |
| | | | | 19% Other (mixture of |
| | | | | decahedral, cubocahedral, |
| | | | | and truncated bitetrahedral |
| | | | | particles) |
| W-4 | 402 | 33 | 25.4 ± 1.2 | Cubic (rounded) |

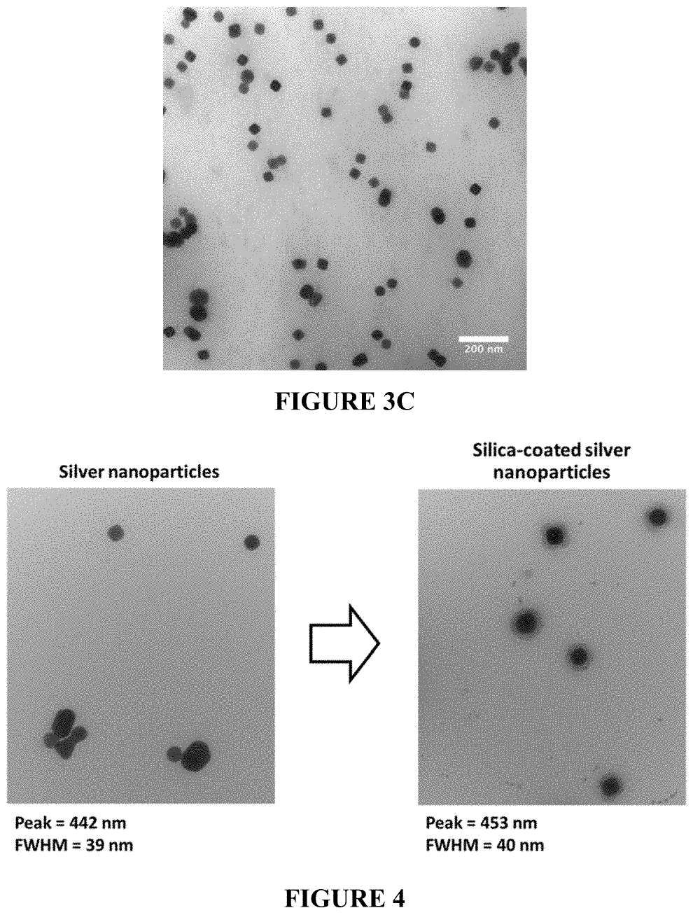

FIG. 4 includes TEM micrographs showing a sample of plasmonic silver nanoparticle cores (Example W-19) before and after coating with a dielectric silica shell. The table below summarizes the absorption (and the full at width half maximum (FWHM)) of six example silver plasmonic nanoparticles before coating with SiO2 (a dielectric layer), after coating with SiO₂, and following washing. As shown below, formation of the dielectric layer induces a redshift in the absorption of the plasmonic core. However, the width of the absorption spectra (as indicated by the FWHM values, stays relatively constant.

| | Initial Absorbance | 12 Hour | |
|---|---|---|---|
| Example | (FWHM) (nm) | Si Coating | Wash |
| W-18 | 431 (42) | 444 (44) | 444 (50) |
| W-19 | 442 (39) | 453 (40) | 454 (44) |
| W-20 | 443 (39) | 458 (42) | 457 (42) |
| W-21 | 446 (50) | 459 (50) | 459 (53) |
| W-22 | 439 (44) | 449 (45) | 450 (47) |
| W-23 | 430 (40) | 440 (39) | 443 (46) |

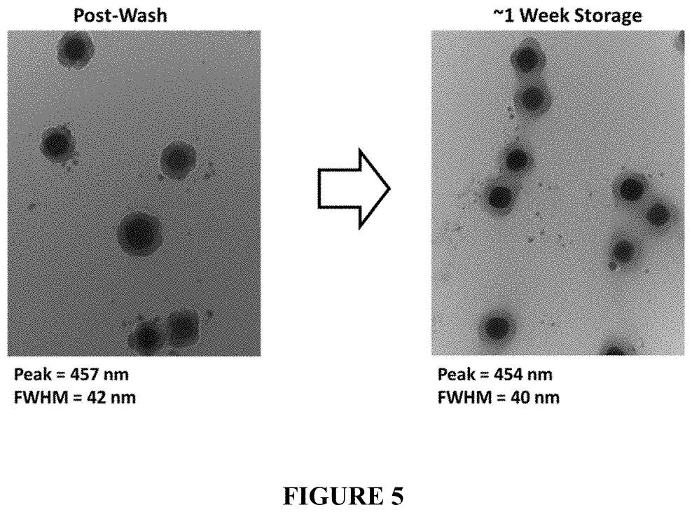

FIG. 5 includes TEM micrographs showing a sample of core-shell particles (Example W-19) post-wash and after storage for approximately one week. The table below summarizes the absorption (and the full at width half maximum (FWHM)) of six example core-shell particles post-wash, after storage for approximately one week, and after storage for approximately two weeks. As shown in the table below, the particles (and their optical properties) remain relatively stable upon storage, demonstrating the ability of the dielectric shell to prevent redshifting and/or broadening of the absorption upon aggregation.

| Example | Wash | ~1 Week | ~2 Weeks |
|---|---|---|---|
| W-18 | 444 (50) | 441 (45) | 440 (44) |
| W-19 | 454 (44) | 451 (45) | 451 (42) |
| W-20 | 457 (42) | 454 (40) | 455 (41) |
| W-21 | 459 (53) | 456 (49) | 457 (49) |
| W-22 | 450 (47) | 448 (46) | 449 (46) |
| W-23 | 443 (46) | 442 (45) | 443 (46) |

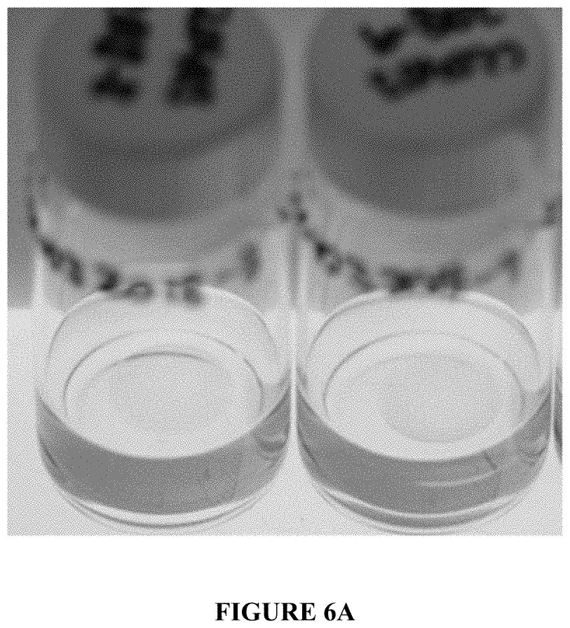

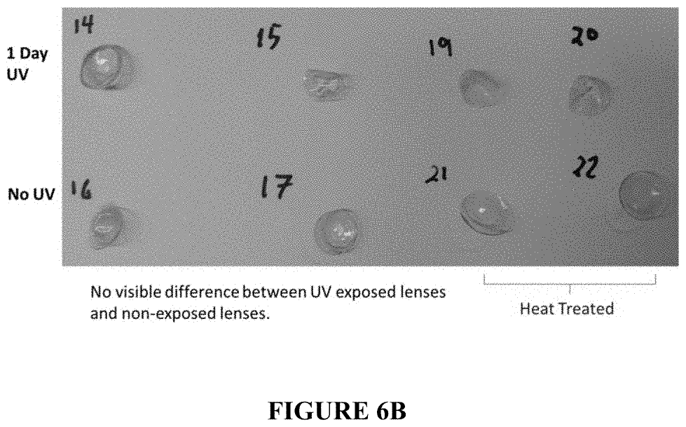

FIG. 6A is a photograph showing example contact lenses prepared containing core-shell particles. The core-shell nanoparticles are dispersed within the silicone hydrogel forming the contact lenses.

FIG. 6B illustrates the effect of UV exposure on contact lenses containing core-shell particles. Lenses 14, 15, 19, and 20 were exposed to UVA light for 24 hours while lenses 16, 17, 21, and 22 were not exposed to UVA light. Lenses 19, 20, 21, and 22 were also heat treated while lenses 14, 15, 16, and 17 were not heat treated. No visible difference was observed between UV exposed lenses and non-exposed lenses.

The materials and devices of the appended claims are not limited in scope by the specific materials and devices described herein, which are intended as illustrations of a few aspects of the claims. Any materials and devices that are functionally equivalent are intended to fall within the scope of the claims. Various modifications of the materials and devices in addition to those shown and described herein are intended to fall within the scope of the appended claims. Further, while only certain representative materials and devices disclosed herein are specifically described, other combinations of the materials and devices also are intended to fall within the scope of the appended claims, even if not specifically recited. Thus, a combination of elements, components, or constituents may be explicitly mentioned herein or less, however, other combinations of elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. A population of core-shell particles, each of the core-shell particles comprising:
a plasmonic nanoparticle core comprising a noble metal; and
a shell comprising a dielectric material surrounding the plasmonic nanoparticle core;
wherein the population of core-shell particles exhibits a maximum absorption value in a range of from 400 nm to 500 nm; and
wherein the population of core-shell particles exhibits an absorption spectrum having a full-width at half maximum of from 20 nm to 75 nm.

2. The particles of claim 1, wherein the population of core-shell particles exhibits a maximum absorption value in a range of from 400 nm to 460 nm.

3. The particles of claim 1, wherein the wherein the noble metal comprises silver.

4. The particles of claim 1, wherein the dielectric material comprises silicon dioxide.

5. The particles of claim 1, wherein the plasmonic nanoparticle core has an average particle size of from 5 nm to 100 nm, as measured by transmission electron microscopy (TEM).

6. The particles of claim 1, wherein the plasmonic nanoparticle core has an average particle size of from 20 nm to 60 nm, as measured by transmission electron microscopy (TEM).

7. The particles of claim 1, wherein the plasmonic nanoparticle cores have a monodisperse particle size distribution.

8. The particles of claim 1, wherein the plasmonic nanoparticle cores have a homogenous particle shape.

9. The particles of claim 8, wherein the plasmonic nanoparticle cores have a polyhedral shape.

10. The particles of claim 9, wherein the plasmonic nanoparticle cores have a cubic shape, an octahedral shape, a decahedral shape, a cuboctahedral shape, a tetrahedral shape, a rhombic dodecahedral shape, a truncated ditetragonal prismatic shape, or a truncated bitetrahedral shape.

11. The particles of claim 1, wherein the plasmonic nanoparticle cores comprise a mixture of particle shapes.

12. The particles of claim 11, wherein the plasmonic nanoparticle cores comprise a first population of plasmonic nanoparticle cores having a cubic shape and a second population of plasmonic nanoparticle cores having an octahedral shape.

13. The particles of claim 1, wherein the shells have an average thickness of from 1 nm to 100 nm, as measured by transmission electron microscopy (TEM).

14. The particles of claim 1, wherein the shells have an average thickness of from 15 nm to 50 nm, as measured by transmission electron microscopy (TEM).

15. A population of core-shell particles, each of the core-shell particles comprising:
a plasmonic nanoparticle core comprising silver; and
a shell comprising silicon dioxide surrounding the plasmonic nanoparticle core;
wherein the plasmonic nanoparticle cores have an average particle size and the shells have an average thickness; and
wherein the ratio of the average particle size to the average thickness is from 1:5 to 20:1, as measured by transmission electron microscopy (TEM).

16. The particles of claim 15, wherein the ratio of the average particle size to the average thickness is from 2:3 to 6:1, as measured by transmission electron microscopy (TEM).

17. The particles of claim 15, wherein the population of core-shell particles exhibits a maximum absorption value in a range of from 400 nm to 500 nm.

18. The particles of claim 15, wherein the population of core-shell particles exhibits a maximum absorption value in a range of from 400 nm to 460 nm.

19. The particles of claim 15, wherein the population of core-shell particles exhibits an absorption spectrum having a full-width at half maximum of from 20 nm to 75 nm.

20. The particles of claim 15, wherein the plasmonic nanoparticle core has an average particle size of from 5 nm to 100 nm, as measured by transmission electron microscopy (TEM).

21. The particles of claim 15, wherein the plasmonic nanoparticle core has an average particle size of from 20 nm to 60 nm, as measured by transmission electron microscopy (TEM).

22. The particles of claim 15, wherein the plasmonic nanoparticle cores have a monodisperse particle size distribution.

23. The particles of claim 15, wherein the plasmonic nanoparticle cores have a homogenous particle shape.

24. The particles of claim 23, wherein the plasmonic nanoparticle cores have a polyhedral shape.

25. The particles of claim 24, wherein the plasmonic nanoparticle cores have a cubic shape, an octahedral shape, a decahedral shape, a cuboctahedral shape, a tetrahedral shape, a rhombic dodecahedral shape, a truncated ditetragonal prismatic shape, or a truncated bitetrahedral shape.

26. The particles of claim 15, wherein the plasmonic nanoparticle cores comprise a mixture of particle shapes.

27. The particles of claim 26, wherein the plasmonic nanoparticle cores comprise a first population of plasmonic nanoparticle cores having a cubic shape and a second population of plasmonic nanoparticle cores having an octahedral shape.

28. The particles of claim 15, wherein the shells have an average thickness of from 1 nm to 100 nm, as measured by transmission electron microscopy (TEM).

29. The particles of claim 15, wherein the shells have an average thickness of from 15 nm to 50 nm, as measured by transmission electron microscopy (TEM).

30. An optically transparent material comprising:
a substrate; and
a population a population of core-shell particles disposed within the substrate, each of the core-shell particles comprising:
(i) a silver core; and
(ii) a non-metallic shell comprising a dielectric material surrounding the silver core.

31. The material of claim 30, wherein the population of core-shell particles exhibits a maximum absorption value in a range of from 400 nm to 500 nm.

32. The material of claim 30, wherein the population of core-shell particles exhibits a maximum absorption value in a range of from 400 nm to 460 nm.

33. The material of claim 30, wherein the population of core-shell particles exhibits an absorption spectrum having a full-width at half maximum of from 20 nm to 75 nm.

34. The material of claim 30, wherein the silver cores have an average particle size of from 5 nm to 100 nm, as measured by transmission electron microscopy (TEM).

35. The material of claim 30, wherein the silver cores have an average particle size of from 20 nm to 60 nm, as measured by transmission electron microscopy (TEM).

36. The material of claim 30, wherein the silver cores have a monodisperse particle size distribution.

37. The material of claim 30, wherein the silver cores have a homogenous particle shape.

38. The material of claim 37, wherein the silver cores have a polyhedral shape.

39. The material of claim 38, wherein the silver cores have a cubic shape, an octahedral shape, a decahedral shape, a cuboctahedral shape, a tetrahedral shape, a rhombic dodecahedral shape, a truncated ditetragonal prismatic shape, or a truncated bitetrahedral shape.

40. The material of claim 30, wherein the silver cores comprise a mixture of particle shapes.

41. The material of claim 40, wherein the silver cores comprise a first population of silver cores having a cubic shape and a second population of silver cores having an octahedral shape.

42. The material of claim 30, wherein the shells have an average thickness of from 1 nm to 100 nm, as measured by transmission electron microscopy (TEM).

43. The material of claim 30, wherein the shells have an average thickness of from 15 nm to 50 nm, as measured by transmission electron microscopy (TEM).

44. The material of claim 30, wherein the silver cores have an average particle size and the non-metallic shells have an average thickness, and wherein the ratio of the average particle size to the average thickness is from 1:5 to 20:1, as measured by transmission electron microscopy (TEM).

45. An optically transparent material comprising:
a substrate; and
a population a population of core-shell particles disposed within the substrate, each of the core-shell particles comprising:
(i) a plasmonic nanoparticle core comprising a noble metal; and
(ii) a non-metallic shell comprising a dielectric material surrounding the plasmonic nanoparticle core
wherein the population of core-shell particles exhibits a maximum absorption value in a range of from 400 nm to 500 nm.

46. The material of claim 45, wherein the wherein the noble metal comprises silver.

47. The material of claim 45, wherein the dielectric material comprises silicon dioxide.

48. The material of claim 45, wherein the population of core-shell particles exhibits a maximum absorption value in a range of from 400 nm to 500 nm.

49. The material of claim 45, wherein the population of core-shell particles exhibits a maximum absorption value in a range of from 400 nm to 460 nm.

50. The material of claim 45, wherein the population of core-shell particles exhibits an absorption spectrum having a full-width at half maximum of from 20 nm to 75 nm.

51. The material of claim 45, wherein the plasmonic nanoparticle cores have an average particle size of from 5 nm to 100 nm, as measured by transmission electron microscopy (TEM).

52. The material of claim 45, wherein the plasmonic nanoparticle cores have an average particle size of from 20 nm to 60 nm, as measured by transmission electron microscopy (TEM).

53. The material of claim 45, wherein the plasmonic nanoparticle cores have a monodisperse particle size distribution.

54. The material of claim 45, wherein the plasmonic nanoparticle cores have a homogenous particle shape.

55. The material of claim 54, wherein the plasmonic nanoparticle cores have a polyhedral shape.

56. The material of claim 55, wherein the plasmonic nanoparticle cores have a cubic shape, an octahedral shape, a decahedral shape, a cuboctahedral shape, a tetrahedral shape, a rhombic dodecahedral shape, a truncated ditetragonal prismatic shape, or a truncated bitetrahedral shape.

57. The material of claim 45, wherein the plasmonic nanoparticle cores comprise a mixture of particle shapes.

58. The material of claim 57, wherein the plasmonic nanoparticle cores comprise a first population of plasmonic nanoparticle cores having a cubic shape and a second population of plasmonic nanoparticle cores having an octahedral shape.

59. The material of claim 45, wherein the shells have an average thickness of from 1 nm to 100 nm, as measured by transmission electron microscopy (TEM).

60. The material of claim 45, wherein the shells have an average thickness of from 15 nm to 50 nm, as measured by transmission electron microscopy (TEM).

61. The material of claim 45, wherein the plasmonic nanoparticle cores have an average particle size and the non-metallic shells have an average thickness, and wherein the ratio of the average particle size to the average thickness is from 1:5 to 20:1, as measured by transmission electron microscopy (TEM).

62. The material of claim 30, wherein the population a population of core-shell particles are present in the substrate at a concentration of from 0.05% by weight to 10% by weight, based on the total weight of the substrate.

63. The material of claim 30, wherein the substrate comprises a glass, allyl diglycol carbonate (ADC), a polycarbonate, a polyurethane, a thiourethane, a poly(meth)acrylate, a silicone hydrogel, or a combination thereof

64. The material of claim 30, wherein the substrate comprises a polymer derived from polymerization of a hydrophilic monomer, a silicone-containing component, or combinations thereof.

65. The material of claim 30, wherein the substrate comprises a silicone hydrogel.

66. An optical lens comprising the material of claim 30.

67. The lens of claim 67, wherein the lens comprises an eyeglass lens.

68. Eyeglasses comprising
a first eyeglass lens defined by claim 67;
a second eyeglass lens defined by claim 67; and
a frame disposed about the first eyeglass lens and the second eyeglass lens.

69. An ophthalmic device comprising the material of claim 30.

70. The ophthalmic device of claim 69, wherein the ophthalmic device is a contact lens, a corneal onlay, a corneal inlay, an intraocular lens, or an overlay lens.
